(19) United States
(12) Patent Application Publication
(10) Pub. No.: US 2016/0261859 A1
(43) Pub. Date: Sep. 8, 2016

(54) STEREOSCOPIC DISPLAY DEVICE

(71) Applicant: Sharp Kabushiki Kaisha, Osaka-shi, Osaka (JP)

(72) Inventors: Takehiro MURAO, Osaka-shi (JP); Ryoh KIKUCHI, Osaka-shi (JP); Takuto YOSHINO, Osaka-shi (JP); Hiroshi FUKUSHIMA, Osaka-shi (JP)

(21) Appl. No.: 15/031,311

(22) PCT Filed: Aug. 25, 2014
(86) PCT No.: PCT/JP2014/072142

§ 371 Date: Apr. 22, 2016

(30) Foreign Application Priority Data
Oct. 24, 2013 (JP) 2013-221597

(51) Int. Cl. H04N 13/04; G02F 1/1343; G02F 1/31; G02F 1/1337; G02B 27/22; G02B 27/26

(52) U.S. Cl. CPC H04N 13/0468; G02B 27/2214; G02B 27/26; G02F 1/31; G02F 1/133784; G02F 1/134309; H04N 13/0409

(57) ABSTRACT

A configuration of a stereoscopic display device that is capable of reducing luminance variation that occurs when a viewer moves is obtained, by making improvement regarding the angle dependency of luminance. A stereoscopic display device (1) includes: a display panel (10); a switch liquid crystal panel (20); a first polarizing plate (15); a second polarizing plate (24); a position sensor for acquiring position information of a viewer; and a control unit for moving a parallax barrier in which transmitting regions and non-transmitting regions are formed in periodic fashion in a predetermined alignment direction, in such a manner that the parallax barrier is moved in the predetermined alignment direction in accordance with the position information, and causing the switch liquid crystal panel (20) to display the parallax barrier. The transmitting region has a width greater than a width in the alignment direction of an opening of each of the pixels (110). The switch liquid crystal panel (20) includes: a first substrate (21); a first alignment film (216); a second substrate (22); a second alignment film (226); and a liquid crystal layer (23). The rubbing direction of the first alignment film (216) is parallel to the transmission axis of the first polarizing plate (15), and the rubbing direction of the second alignment film (226) is parallel to the transmission axis of the second polarizing plate (24).

### TECHNICAL FIELD

The present invention relates to a naked-eye stereoscopic display device.

### BACKGROUND ART

As a stereoscopic display device that can be viewed with naked eyes, those of a parallax barrier type and a lenticular lens type are known. The stereoscopic display devices of these types separate light using barriers or lenses, and cause different images to be visible to the right and left eyes, respectively, so as to provide a stereoscopic vision to the viewer. In recent years, main types of naked-eye stereoscopic display devices that are in the market are those of the two-viewpoint parallax barrier type and those of the lenticular lens type.

In the case of such a two-viewpoint stereoscopic display device, excellent stereoscopic display can be achieved from a predetermined region, but there also exists the following region: when a viewer moves the head to the region, a so-called crosstalk occurs, which is such a phenomenon that an image to be visible to the right eye and an image to be visible to the left eye are mixed and viewed as a double image, or a state of a so-called pseudoscopic vision occurs, which is such a phenomenon that an image to be visible to the right eye is visible to the left eye. Therefore, only from a limited region, a viewer can view stereoscopic images. To address this problem, the multiple-viewpoint technique, the tracking technique of detecting the position of the head of a viewer and displaying an image according to the position and the like have been proposed.

Further, a technique of a switch liquid crystal display (SW-LCD) of a barrier division type has been proposed, wherein a parallax barrier is formed with a liquid crystal panel and is moved according to the position of a viewer. In the case of the SW-LCD technique, if conditions for the parallax barrier formation and the like are not appropriate, luminance variation and increase of crosstalk occur upon the switching of the parallax barrier, in some cases.

JP2013-24957A discloses a display device that includes: a display panel on which pairs of subpixels are arrayed in a lateral direction; and a parallax barrier shutter panel on which sub-openings whose light transmitting state and light blocking state can be switchable are arrayed in the lateral direction. In this display device, among a plurality of sub-openings corresponding to a reference parallax barrier pitch, an arbitrary number of adjacent sub-openings are turned to be in the light transmitting state, and the other sub-openings are turned to be in the light blocking state, whereby integrated openings obtained are formed in the parallax barrier shutter panel. Then, the sub-opening pitch is equal to or smaller than the difference between the width of the subpixel and the width of the integrated opening.

### DISCLOSURE OF THE INVENTION

The display device disclosed in JP-A-2013-24957 is capable of achieving excellent quality in a case where there is no delay time upon switching of the parallax barrier. Actually, however, delay time exists due to, for example, the response speed of liquid crystal, and therefore luminance variation and increase of crosstalk occur in some cases.

An object of the present invention is to provide a configuration of a stereoscopic display device that is capable of reducing luminance variation that occurs when a viewer moves, by making improvement regarding the angle dependency of luminance.

A stereoscopic display device disclosed herein includes: a display panel for displaying an image with a plurality of pixels; a switch liquid crystal panel that is arranged on a viewer side with respect to the display panel; a first polarizing plate arranged between the display panel and the switch liquid crystal panel; a second polarizing plate arranged on the viewer side with respect to the switch liquid crystal panel; a position sensor for acquiring position information of a viewer; and a control unit for moving a parallax barrier in which transmitting regions and non-transmitting regions are formed in periodic fashion in a predetermined alignment direction, in such a manner that the parallax barrier is moved in the predetermined alignment direction in accordance with the position information, and causing the switch liquid crystal panel to display the parallax barrier. The transmitting region has a width greater than a width in the alignment direction of an opening of each of the pixels. The switch liquid crystal panel includes: a first substrate arranged on a side of the display panel; a first alignment film formed on the first substrate; a second substrate arranged so as to be opposed to the first substrate; a second alignment film formed on the second substrate; and a liquid crystal layer arranged between the first substrate and the second substrate. The rubbing direction of the first alignment film is parallel to the transmission axis of the first polarizing plate, and the rubbing direction of the second alignment film is parallel to the transmission axis of the second polarizing plate.

The present invention makes it possible to make improvement regarding the angle dependency of luminance, thereby obtaining a configuration of a stereoscopic display device that is capable of reducing luminance variation that occurs when a viewer moves.

### BRIEF DESCRIPTION OF DRAWINGS

FIG. 1 is a schematic cross-sectional view illustrating a configuration of a stereoscopic display device according to Embodiment 1 of the present invention.

FIG. 2 is a block diagram illustrating a functional configuration of the stereoscopic display device according to Embodiment 1 of the present invention.

FIG. 3 is a flowchart of a processing by the stereoscopic display device according to Embodiment 1 of the present invention.

FIG. 4A is a view for explaining stereoscopic display in a case where a parallax barrier is fixed.

FIG. 4B is a view for explaining stereoscopic display in a case where a parallax barrier is fixed.

FIG. 4C is a view for explaining stereoscopic display in a case where a parallax barrier is fixed.

FIG. 5A is a view for explaining principles of the stereoscopic display by the stereoscopic display device according to Embodiment 1 of the present invention.

FIG. 5B is a view for explaining principles of the stereoscopic display by the stereoscopic display device according to Embodiment 1 of the present invention.

FIG. 5C is a view for explaining principles of the stereoscopic display by the stereoscopic display device according to Embodiment 1 of the present invention.

FIG. 6A is a plan view illustrating a configuration of a first substrate of a switch liquid crystal panel.

FIG. 6B is a plan view illustrating a configuration of a second substrate of the switch liquid crystal panel.

FIG. 7 is a cross-sectional view illustrating a schematic configuration of a stereoscopic display device according to Embodiment 1 of the present invention.

FIG. 8 is an enlarged cross-sectional view illustrating a part of the switch liquid crystal panel.

FIG. 9 is a plan view schematically illustrating the relationship among a direction DR0 parallel to a transmission axis of a polarizing plate on an emission side of a display panel, a rubbing direction DR1 of an alignment film formed on a first substrate, a rubbing direction DR2 of an alignment film formed on a second substrate.

FIG. 10 schematically illustrates the relationship among the rubbing direction DR1, the rubbing direction DR2, the direction DR0 of the transmission axis of the polarizing plate on the display panel side, and a direction DR3 of a transmission axis of a polarizing plate on the viewer side.

FIG. 11A is a view for explaining a twist direction of liquid crystal molecules.

FIG. 11B is a view for explaining a twist direction of liquid crystal molecules.

FIG. 12A is a view for explaining a twist direction of liquid crystal molecules.

FIG. 12B is a view for explaining a twist direction of liquid crystal molecules.

FIG. 13A is a view for explaining an exemplary method for producing the first substrate.

FIG. 13B is a view for explaining an exemplary method for producing the first substrate.

FIG. 13C is a view for explaining an exemplary method for producing the first substrate.

FIG. 14A is a cross-sectional view schematically illustrating one barrier lighting state to be displayed on a switch liquid crystal panel.

FIG. 14B is a cross-sectional view schematically illustrating another barrier lighting state to be displayed on a switch liquid crystal panel.

FIG. 15 is a plan view for explaining a configuration of pixels of a display panel.

FIG. 16 schematically illustrates the relationship between pixels, and barriers as well as slits formed by the switch liquid crystal panel.

FIG. 17 schematically illustrates angle characteristics of luminance of a stereoscopic display device.

FIG. 18A is an enlarged view of a portion surrounded by an alternate long and two short dashed line XVIII in FIG. 17, schematically illustrating luminance variation in a case where a viewer relatively slowly moved.

FIG. 18B is an enlarged view of a portion surrounded by an alternate long and two short dashed line XVIII in FIG. 17, schematically illustrating luminance variation in a case where a viewer relatively quickly moved.

FIG. 19A schematically illustrates a case where the width of a slit is narrower than that of an opening.

FIG. 19B schematically illustrates a case where the width of the slit is approximately equal to that of the opening.

FIG. 19C schematically illustrates a case where the width of the slit is wider than that of the opening.

FIG. 20 schematically illustrates angle characteristics of luminance in a case where the width of the slit is varied.

FIG. 20A is a cross-sectional view schematically illustrating a state before the barrier lighting state is switched.

FIG. 21B is a cross-sectional view schematically illustrating a state during the switching of the barrier lighting state.

FIG. 21C is a cross-sectional view schematically illustrating a state after the barrier lighting state is switched.

FIG. 22A schematically illustrates behavior of light in a case where the switch liquid crystal panel is arranged on a viewer side with respect to the display panel.

FIG. 22B schematically illustrates behavior of light in a case where the display panel is arranged on a viewer side with respect to the switch liquid crystal panel.

FIG. 23 schematically illustrates luminance characteristics in a case where a lens effect is not taken into consideration, and luminance characteristics in a case where the lens effect is taken into consideration.

FIG. 24 illustrates luminance characteristics when rubbing directions of alignment films of the first and second substrates and angles of axes of polarizing plates are varied.

FIG. 25 is a view obtained by focusing on and enlarging the curves C1 and C4 illustrated in FIG. 24.

FIG. 26 is a cross-sectional view illustrating a schematic configuration of a stereoscopic display device according to Embodiment 2 of the present invention.

FIG. 27 is an enlarged cross-sectional view of a part of a switch liquid crystal panel.

FIG. 28 is a cross-sectional view schematically illustrating another barrier lighting state of the switch liquid crystal panel.

FIG. 29 is a table illustrating configurations of produced stereoscopic display devices, and evaluation results of the stereoscopic display devices regarding the crosstalk and the lens effect.

### MODE FOR CARRYING OUT THE INVENTION

A stereoscopic display device according to one embodiment of the present invention includes: a display panel for displaying an image with a plurality of pixels; a switch liquid crystal panel that is arranged on a viewer side with respect to the display panel; a first polarizing plate arranged between the display panel and the switch liquid crystal panel; a second polarizing plate arranged on the viewer side with respect to the switch liquid crystal panel; a position sensor for acquiring position information of a viewer; and a control unit for moving a parallax barrier in which transmitting regions and non-transmitting regions are formed in periodic fashion in a predetermined alignment direction, in such a manner that the parallax barrier is moved in the predetermined alignment direction in accordance with the position information, and causing the switch liquid crystal panel to display the parallax barrier. The transmitting region has a width greater than a width in the alignment direction of an opening of each of the pixels. The switch liquid crystal panel includes: a first substrate arranged on a side of the display panel; a first alignment film formed on the first substrate; a second substrate arranged so as to be opposed to the first substrate; a second alignment film formed on the second substrate; and a liquid crystal layer arranged between the first substrate and the second substrate. The rubbing direction of the first alignment film is parallel to the transmission axis of the first polarizing plate, and the rubbing direction of the second alignment film is parallel to the transmission axis of the second polarizing plate (the first configuration).

According to the above-described configuration, on the switch liquid crystal panel, a parallax barrier in which transmitting regions and non-transmitting regions are formed in periodic fashion in the predetermined alignment direction are displayed. With this configuration, when a viewer views the stereoscopic display device at an appropriate position, an image of a part of the display panel is visible to the right eye, and an image of the other part of the display panel is visible to the left eye. This allows the viewer to have a stereoscopic vision. The control unit moves the parallax barrier according to the position information of the viewer. This makes it possible to display a normal stereoscopic image always, even if the viewer moves.

Further, by setting the width of the transmitting region greater than the width of the opening of each of the pixels, a pixel to be displayed can be prevented from being shielded by the non-transmitting region, even if the viewer moves more or less away from the appropriate position. Improvement, therefore, can be achieved regarding the angle dependency of luminance.

The switch liquid crystal panel is arranged on the viewer side with respect to the display panel. Here, the switch liquid crystal panel works as a lens, and gathers light from the display panel, thereby deteriorating the luminance characteristics, in some cases.

According to the above-described configuration, the rubbing direction of the first alignment film is set to be parallel to the transmission axis of the first polarizing plate, and the rubbing direction of the second alignment film is set to be parallel to the transmission axis of the second polarizing plate. This makes it possible to reduce the lens effect, as compared with the case where the rubbing direction of the first alignment film is set to be parallel to the absorption axis of the first polarizing plate and the rubbing direction of the second alignment film is set to be parallel to the absorption axis of the second polarizing plate. By reducing the lens effect, improvement can be achieved regarding the angle dependency of luminance.

In the first configuration described above, preferably, the rubbing direction of the second alignment film is a direction obtained by twisting the rubbing direction of the first alignment film clockwise as viewed from the viewer side (the second configuration).

According to the above-described configuration, the rubbing direction of the second alignment film is set to a direction obtained by twisting the rubbing direction of the first alignment film counterclockwise as viewed from the viewer side. With this, when no voltage is applied across the first substrate and the second substrate, the alignment direction of the liquid crystal molecules of the liquid crystal layer of the switch liquid crystal panel rotates counterclockwise from the first substrate toward the second substrate, as viewed from the light source side. As compared with a case where the alignment direction of the liquid crystal molecules is caused to rotate clockwise, the lens effect can be reduced. By reducing the lens effect, improvement can be achieved regarding the angle dependency of luminance.

In the first or second configuration described above, preferably, the control unit moves the parallax barrier with use of a predetermined barrier switching pitch as a minimum unit, and the width in the alignment direction of the opening of each of the pixels, which is given as “A”, satisfies the following expressions:

A≦Wsl−2Pe, and

A≦Wbr−2Pe

where Wsl is a width of the transmitting region, Wbr is a width of the non-transmitting region, and Pe is the barrier switching pitch (the third configuration).

According to the above-described configuration, the width of the opening is equal to or less than a value determined by subtracting the width of liquid crystal that operates during the switching of the parallax barrier (a width twice the barrier switching pitch) from the width of the transmitting region. Besides, the width of the opening is equal to or less than a value determined by subtracting the width of liquid crystal that operates during the switching of the parallax barrier (a width twice the barrier switching pitch) from the width of the non-transmitting region. With this configuration, over a period before and after the switching of the barrier lighting state, pixels to be displayed are by no means shielded by the non-transmitting regions. Further, over a period before and after the switching of the barrier lighting state, pixels to be shielded by the non-transmitting regions are by no means displayed. This makes it possible to prevent luminance variation from occurring before and after the switching of the barrier lighting state.

In any one of the first to third configurations, preferably, the control unit causes the parallax barrier to be displayed on the switch liquid crystal panel in such a manner that the width of the transmitting region and the width of the non-transmitting region are equal to each other (the fourth configuration).

In any one of the first to fourth configurations, preferably, the rubbing direction of the first alignment film and the rubbing direction of the second alignment film are different by 90° from each other (the fifth configuration).

In the first to fifth configurations, preferably, the switch liquid crystal panel further includes: a first electrode group that includes a plurality of electrodes that are formed on the first substrate and are arranged in the alignment direction at predetermined intervals, and a second electrode group that includes a plurality of electrodes that are formed on the second substrate and are arranged in the alignment direction at the predetermined intervals, and the first electrode group and the second electrode group are arranged so as to be deviated with respect to each other by half of the predetermined interval in the alignment direction (the sixth configuration).

According to the above-described configuration, the barrier switching pitch can be set to half of the interval at which the first electrode group and second electrode group are formed, whereby the parallax barrier position can be switched more finely. This makes it possible to further reduce luminance variation and suppress deterioration regarding crosstalk.

In any one of the first to sixth configurations, the display panel may be a liquid crystal display panel (the seventh configuration).

### EMBODIMENTS

The following describes embodiments of the present invention in detail, while referring to the drawings. In the drawings, identical or equivalent parts in the drawings are denoted by the same reference numerals, and the descriptions of the same are not repeated. To make the explanation easy to understand, in the drawings referred to hereinafter, the configurations are simplified or schematically illustrated, or a part of constituent members are omitted. Further, the dimension ratios of the constituent members illustrated in the drawings do not necessarily indicate the real dimension ratios.

### Embodiment 1

### Overall Configuration

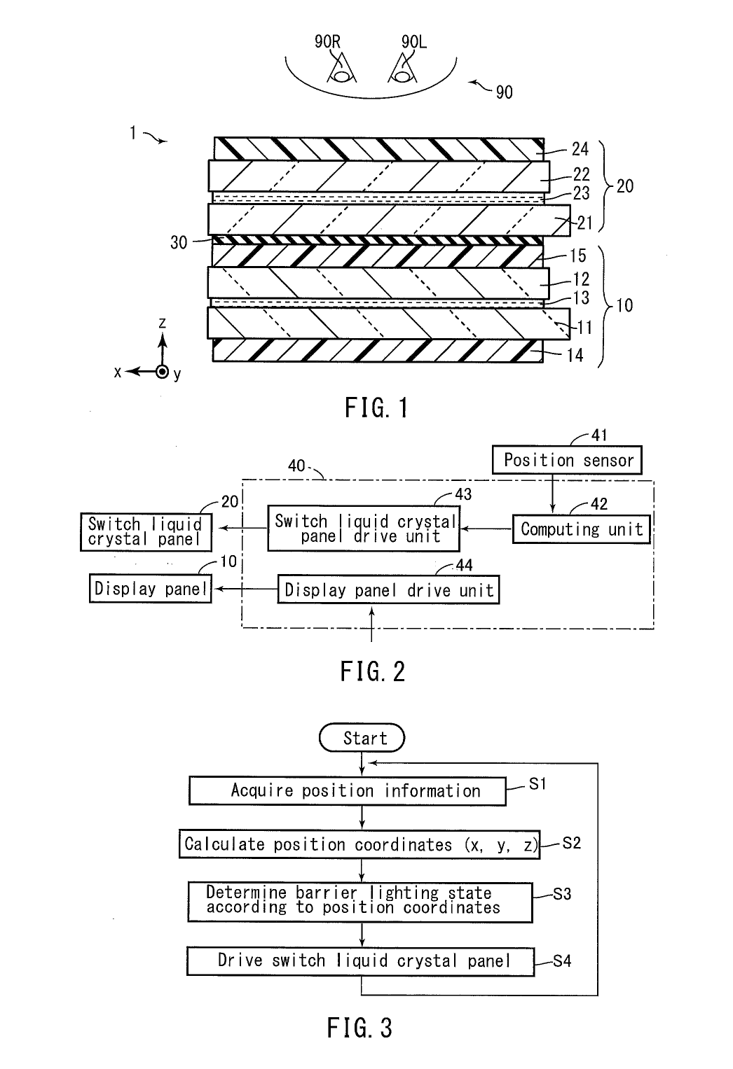

FIG. 1 is a schematic cross-sectional view illustrating a configuration of a stereoscopic display device 1 according to Embodiment 1 of the present invention. The stereoscopic display device 1 includes a display panel 10, a switch liquid crystal panel 20, and an adhesive resin 30. The display panel 10 and the switch liquid crystal panel 20 are arranged so as to be stacked in such a manner that the switch liquid crystal panel 20 is positioned on the viewer 90 side, and are stuck with each other with the adhesive resin 30.

The display panel 10 includes a TFT (thin film transistor) substrate 11, a CF (color filter) substrate 12, a liquid crystal layer 13, and polarizing plates 14 and 15. The display panel 10 controls TFT substrate 11 and the CF substrate 12 so as to operate the alignment of liquid crystal molecules in the liquid crystal layer 13, thereby to display images.

The switch liquid crystal panel 20 includes a first substrate 21, a second substrate 22, a liquid crystal layer 23, and a polarizing plate 24. The first substrate 21 and the second substrate 22 are arranged so as to be opposed to each other. The liquid crystal layer 23 is interposed between the first substrate 21 and the second substrate 22. The polarizing plate 24 is arranged on the viewer 90 side.

Though FIG. 1 does not illustrate detailed configuration, electrodes are formed on the first substrate 21 and the second substrate 22. The switch liquid crystal panel 20 controls potentials of these electrodes so as to operate the alignment of liquid crystal molecules of the liquid crystal layer 23, thereby to change behavior of light passing through the liquid crystal layer 23. More specifically, the switch liquid crystal panel 23 forms non-transmitting regions (barriers) that block light, and transmitting regions (slits) that transmit light, by using the alignment of the liquid crystal molecules of the liquid crystal layer 23 and the operations of the polarizing plate 15 and the polarizing plate 24. The configurations and operations of the first substrate 21 and the second substrate 22 are to be described in detail below.

The TFT substrate 11 and the CF substrate 12 have a thickness of, for example, 200 μm. The polarizing plate 14 and the polarizing plate 15 have a thickness of, for example, 130 μm. The first substrate 21 and the second substrate 22 has a thickness of, for example, 350 μm. The thickness of the adhesive resin 30 is, for example, 50 μm.

The polarizing plate 15 may be arranged on the switch liquid crystal panel 20. More specifically, the configuration may be such that the polarizing plate 15 is arranged on a surface on the display panel 10 side of the first substrate 21 of the switch liquid crystal panel 20, and the adhesive resin 30 is arranged between the polarizing plate 15 and the CF substrate 12.

Hereinafter, a direction parallel to a line extending between the left eye 90L and the right eye 90R of the viewer 90 when the viewer 90 and the stereoscopic display device 1 face each other directly (the x direction in FIG. 1) is referred to as a “horizontal direction”. Further, the direction orthogonal to the horizontal direction in the surface of the display panel 10 (the y direction in FIG. 1) is referred to as a “vertical direction”.

FIG. 2 is a block diagram illustrating a functional configuration of the stereoscopic display device 1. FIG. 3 is a flowchart illustrating a processing operation by the stereoscopic display device 1. The stereoscopic display device 1 further includes a control unit 40 and a position sensor 41. The control unit 40 includes a computing unit 42, a switch liquid crystal panel drive unit 43, and a display panel drive unit 44.

The display panel drive unit 44 drives the display panel 10 based on a video signal that is input from outside, and causes the display panel 10 to display an image.

The position sensor 41 acquires position information regarding the position of the viewer 90 (Step S1). The position sensor 41 is, for example, a camera or an infrared light sensor. The position sensor 41 supplies the acquired position information to the computing unit 42 of the control unit 40.

The computing unit 42 analyzes the position information of the viewer 90 supplied from the position sensor 41, and calculates position coordinates (x, y, z) of the viewer 90 (Step S2). The calculation of the position coordinates can be performed by, for example, an eye tracking system for detecting the position of the eyes of the viewer 90 by image processing. Alternatively, the calculation of the position coordinates may be performed by a head tracking system for detecting the position of the head of the viewer 90 with infrared light.

The computing unit 42 further determines a barrier lighting state of the switch liquid crystal panel 20 according to the position coordinates of the viewer 90 (Step S3). More specifically, according to the position coordinates of the viewer 90, the positions of the barriers and the positions of the slits of the switch liquid crystal panel 20 are determined. The computing unit 42 supplies the determined information of the barrier lighting state to the switch liquid crystal panel drive unit 43.

The switch liquid crystal panel drive unit 43 drives the switch liquid crystal panel 20 based on the information supplied from the computing unit 42 (Step S4). Thereafter, Steps S1 to S4 are repeated.

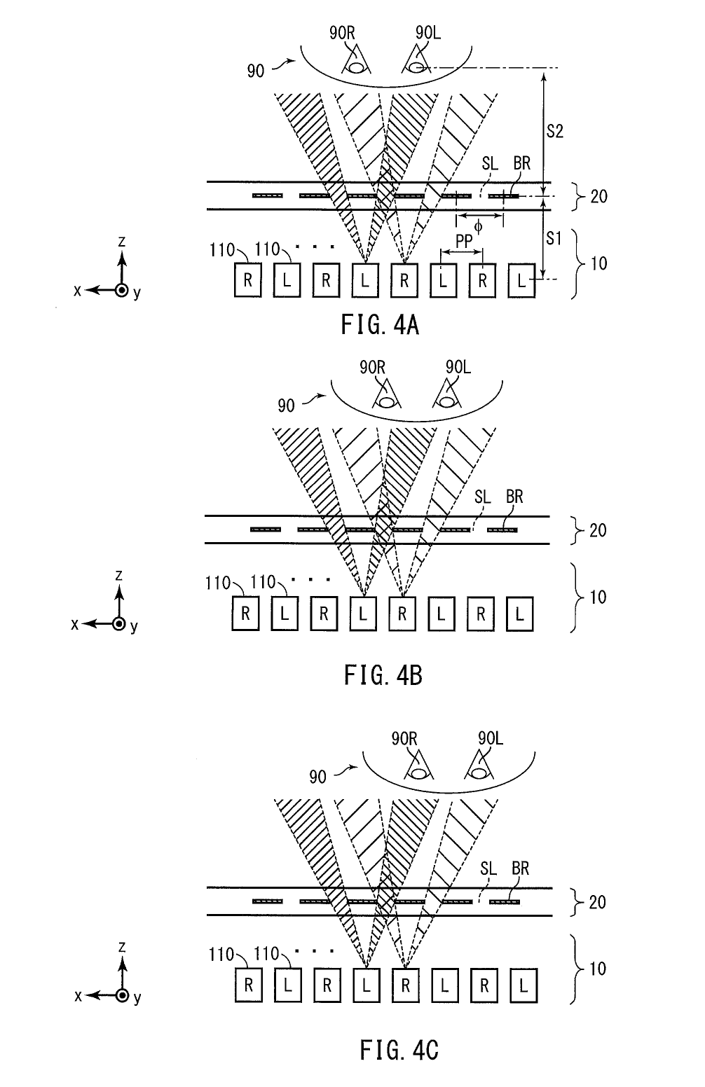

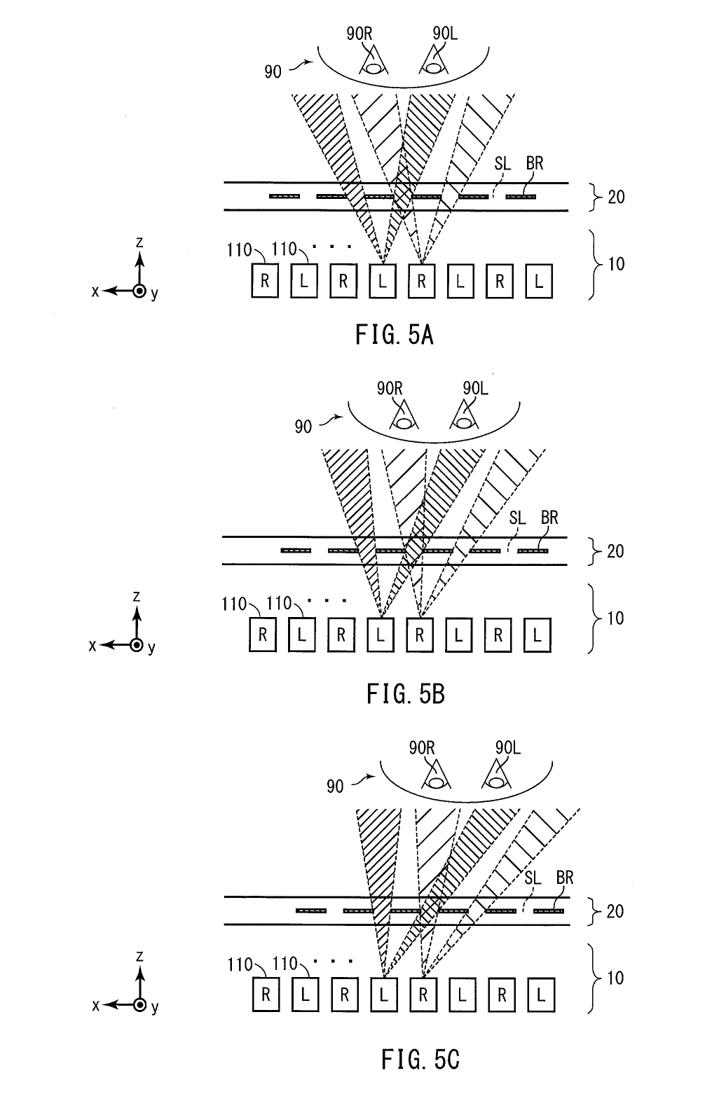

Next, the following description explains principles of the stereoscopic display by the stereoscopic display device 1, using FIGS. 4A to 4C and FIGS. 5A to 5C.

First of all, a case is explained where the barrier lighting state is fixed, with reference to FIGS. 4A to 4C. The display panel 10 includes a plurality of pixels 110. On the pixels 110, a right-eye image (R) and a left-eye image (L) are alternately displayed in the horizontal direction. In the switch liquid crystal panel 20, barriers BR that block light and slits SL that transmit light are formed at predetermined intervals. This allows only the right-eye image (R) to be visible to the right eye 90R of the viewer 90, and allows only the left-eye image (L) to be visible to the left eye 90L, as illustrated in FIG. 4A. This allows the viewer 90 to have a stereoscopic vision.

The interval PP of the pixels 110 and the interval φ of the barriers BR satisfy the following expression when S2 is sufficiently greater than S1:

φ≈2×PP

where S1 is a distance from the display surface of the display panel 10 to the barriers BR, and S2 is a distance from the barriers BR to the viewer 90.

FIG. 4B illustrates a state in which the viewer 90 has moved from the position shown in FIG. 4A in the horizontal direction. In this case, to the right eye 90R of the viewer 90, both of the right-eye image (R) and the left-eye image (L) are visible. Similarly, to the left eye 90L, both of the right-eye image (R) and the left-eye image (L) are visible. In other words, crosstalk is occurring, and the viewer 90 cannot have a stereoscopic vision.

FIG. 4C illustrates a state in which the viewer 90 has further moved from the position shown in FIG. 4B in the horizontal direction. In this case, to the right eye 90R of the viewer 90, the left-eye image (L) is visible, and to the left eye 90L thereof, the right-eye image (R) is visible. In this case, the state of pseudoscopic vision occurs wherein a video image that should be recognized as being positioned behind is observed in the foreground, and in contrast, a video image that should be recognized as being positioned in the foreground is observed behind, which makes the viewer 90 unable to have an appropriate stereoscopic vision, and give uncomfortable feeling to him/her.

In this way, as the viewer 90 moves, a normal area where a stereoscopic vision can be obtained, a crosstalk area where crosstalk occurs, and a pseudoscopic area where the state of pseudoscopic vision occurs, appear repeatedly. Therefore, in the case where the barrier lighting state is fixed, the viewer 90 can have a stereoscopic vision only in limited areas.

In the present embodiment, the control unit 40 changes the barrier lighting state of the switch liquid crystal panel 20 according to the position information (position coordinates) of the viewer 90, as illustrated in FIGS. 5A to 5C. This allows the viewer 90 to have a stereoscopic vision always, and prevents crosstalk and the state of pseudoscopic vision from occurring.

### [Configuration of Switch Liquid Crystal Panel 20]

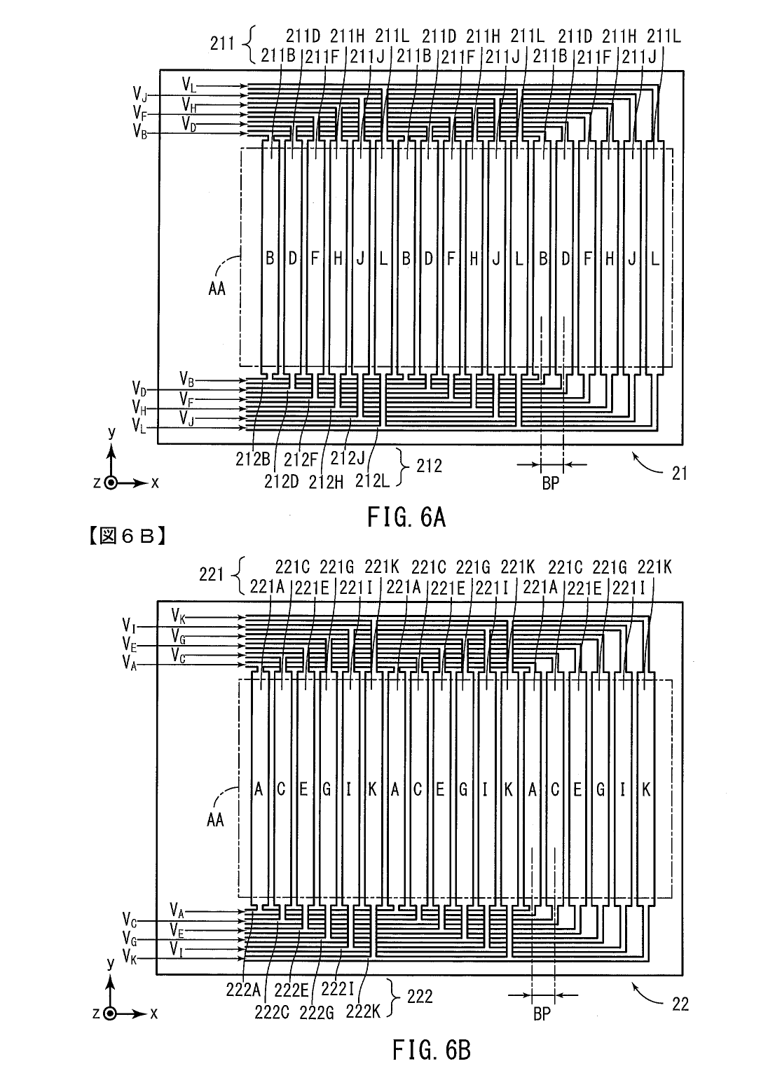

FIG. 6A is a plan view illustrating a configuration of the first substrate 21 of the switch liquid crystal panel 20. On the first substrate 21, a first electrode group 211 is formed. The first electrode group 211 includes a plurality of electrodes arranged in the x direction at electrode intervals BP. Each of the electrodes extends in the y direction, and they are arranged in parallel to one another.

On the first substrate 21, there is further formed a line group 212 that is electrically connected with the first electrode group 211. The line group 212 is preferably formed outside a region that overlaps a display region of the display panel 10 (an active area AA) when the switch liquid crystal panel 20 is stacked on the display panel 10.

FIG. 6B is a plan view illustrating a configuration of the second substrate 22 of the switch liquid crystal panel 20. On the second substrate 22, a second electrode group 221 is formed. The second electrode group 221 includes a plurality of electrodes arranged in the x direction at the electrode intervals BP. Each of the electrodes extends in the y direction, and they are arranged in parallel to one another.

On the second substrate 22, there is further formed a line group 222 that is electrically connected with the second electrode group 221. The line group 222 is preferably formed outside the active area AA, as is the case with the line group 212.

To the first electrode group 211 and the second electrode group 221, signals of twelve systems, i.e., signals V_{A} to V_{L}, are supplied form the control unit 40. More specifically, to the first electrode group 211, signals of six systems, i.e., signals V_{B}, V_{D}, V_{F}, V_{H}, V_{J}, and V_{L} are supplied via the line group 212. To the second electrode group 221, signals of six systems, i.e., signals V_{A}, V_{C}, V_{E}, V_{G}, V_{I}, and V_{K} are supplied via the line group 222.

Hereinafter, the electrodes to which the signals V_{B}, V_{D}, V_{F}, V_{H}, V_{J}, and V_{L} are supplied, among the electrodes of the first electrode group 211, are referred to as electrodes 211B, 211D, 211F, 211H, 211J, and 211L, respectively. Further, lines electrically connected with the electrodes 211B, 211D, 211F, 211H, 211J, and 211L are referred to as lines 212B, 212D, 212F, 212H, 212J, and 212L, respectively.

Regarding the electrodes of the second electrode group 221, similarly, the electrodes to which the signals V_{A}, V_{C}, V_{E}, V_{G}, V_{I}, and V_{K} are supplied are referred to as electrodes 221A, 221C, 221E, 221G, 221I, and 221K, respectively. Further, the lines electrically connected with the electrodes 221A, 221C, 221E, 221G, 221I, and 221K are referred to as lines 222A, 222C, 222E, 222G, 222I, and 222K, respectively.

The electrodes 211B, 211D, 211F, 211H, 211J, and 211L are arranged in periodic fashion in the x direction in the stated order. In other words, the configuration is such that the same signal should be supplied to a certain electrode, and an electrode that is sixth with respect to the certain electrode. Similarly, the electrodes 221A, 221C, 221E, 221G, 221I, and 221K are arranged in periodic fashion in the x direction in the stated order.

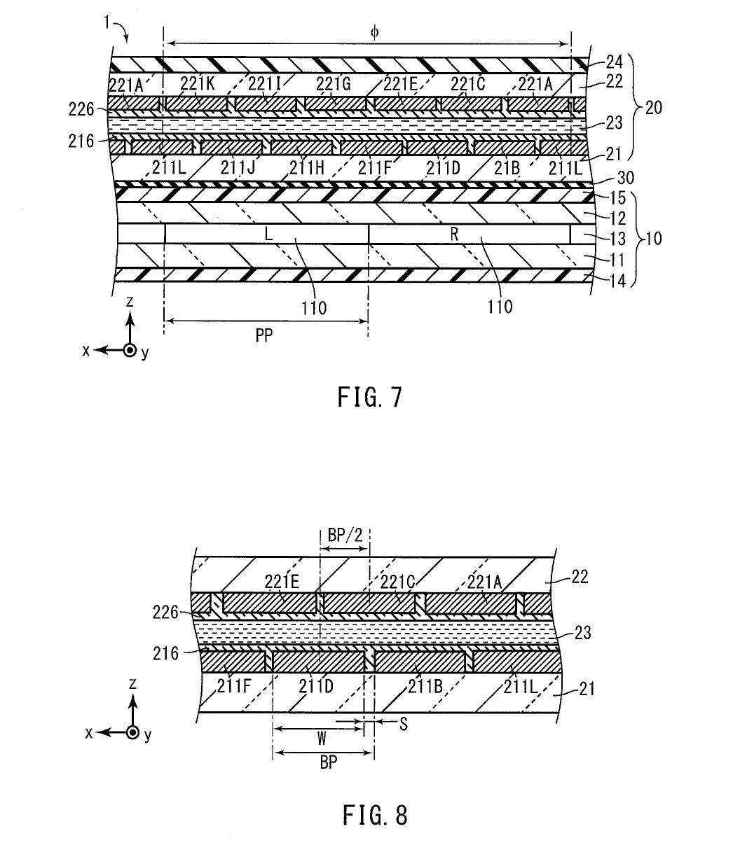

FIG. 7 is a cross-sectional view illustrating a schematic configuration of the stereoscopic display device 1. FIG. 8 is an enlarged cross-sectional view illustrating a part of the switch liquid crystal panel 20. As illustrated in FIGS. 7 and 8, the first electrode group 211 and the second electrode group 221 are arranged so as to be deviated with respect to each other in the x direction. Preferably, the first electrode group 211 and the second electrode group 221 are arranged so as to be deviated with respect to each other in the x direction by half of the electrode interval BP as in the example illustrated in FIG. 8.

It should be noted that the electrode interval BP is a sum of the width W of the electrode and the clearance S between the electrodes. In the present embodiment, the configuration satisfies BP=φ/6≈P/3.

Alignment films 216 and 226 are formed on the first substrate 21 and the second substrate 22, respectively. The alignment film 216 formed on the first substrate 21 and the alignment film 226 formed on the second substrate 22 are rubbed in directions that intersect with each other, respectively. This causes the liquid crystal molecules of the liquid crystal layer 23 to be aligned in a state of the so-called twisted nematic alignment, in which the alignment direction is rotated (twisted) in a region from the first substrate 21 toward the second substrate 22, in a no-voltage applied state.

Further, the polarizing plate 15 and the polarizing plate 24 are arranged in such a manner that the light transmission axes thereof intersect each other. In other words, the liquid crystal of the switch liquid crystal panel 20 according to the present embodiment is so-called normally white liquid crystal, in which the maximum transmittance is obtained when no voltage is applied to the liquid crystal layer 23.

Regarding the configuration of the alignment film, as is the case with the switch liquid crystal panel 20 according to the present embodiment, twisted nematic liquid crystal, which provides high transmittance, is preferably used. Further, regarding the configuration of the polarizing plate, normally white is preferable. Normally white liquid crystal is in a no-voltage-applied state in the two-dimensional display mode, which enables to reduce electric power consumption.

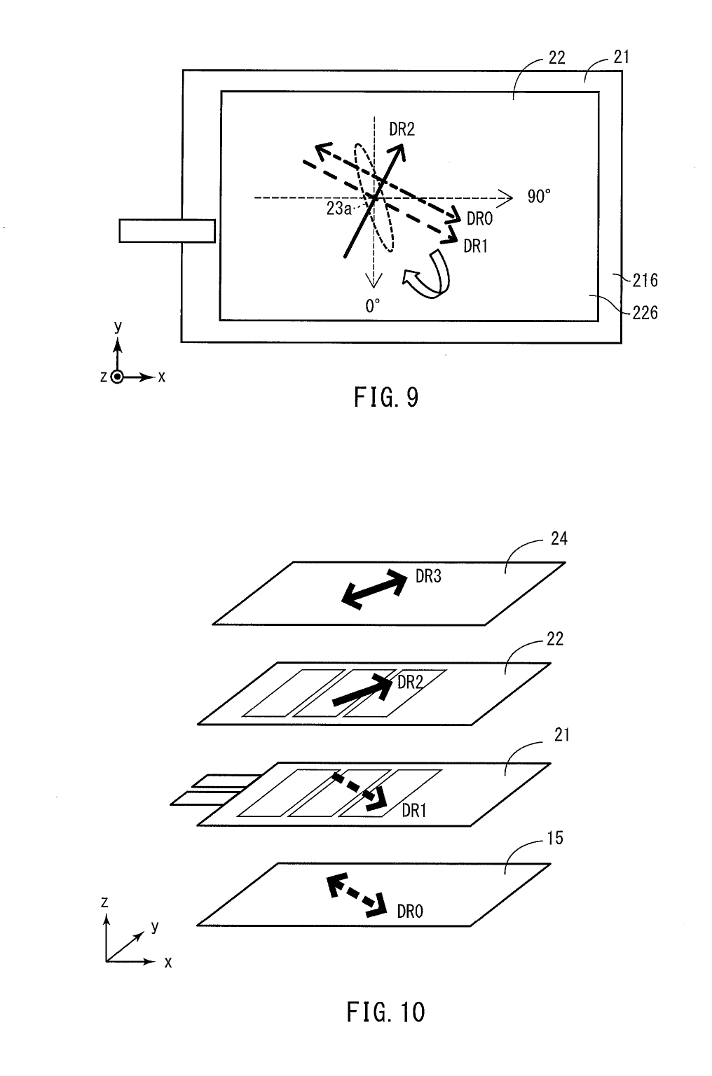

FIG. 9 is a plan view schematically illustrating the relationship among a direction DR0 parallel to a transmission axis of the polarizing plate 15 (FIG. 1, FIG. 10) of the display panel 10, the rubbing direction DR1 of the alignment film 216 formed on the first substrate 21, the rubbing direction DR2 of the alignment film 226 formed on the second substrate 22. A void arrow indicates a rotation direction of liquid crystal molecules in the liquid crystal layer 23 (FIG. 7) from the first substrate 21 to the second substrate 22. An ellipse denoted by the reference symbol 23a schematically represents an alignment direction of liquid crystal molecules in the vicinities of the center in the thickness direction (in the z direction) of the liquid crystal layer 23.

Regarding the direction (angle), as illustrated in FIG. 9, the six-o'clock direction as viewed from the light emission side (the viewer side) (on the minus side in the y direction) is assumed to be 0°, and the counterclockwise direction is assumed to be a plus direction. The rubbing direction DR1 is a direction at an angle of 63° in this coordinate system. The rubbing direction DR2 is a direction at an angle of 153° in this coordinate system.

FIG. 10 schematically illustrates the relationship among the rubbing direction DR1, the rubbing direction DR2, the direction DR0 parallel to the transmission axis of the polarizing plate 15, and the direction DR3 parallel to the transmission axis of the polarizing plate 24. As illustrated in FIG. 10, in the present embodiment, the configuration is such that the transmission axis of the polarizing plate 15 and the rubbing direction DR1 are parallel to each other, and transmission axis of the polarizing plate 24 and the rubbing direction DR2 are parallel to each other.

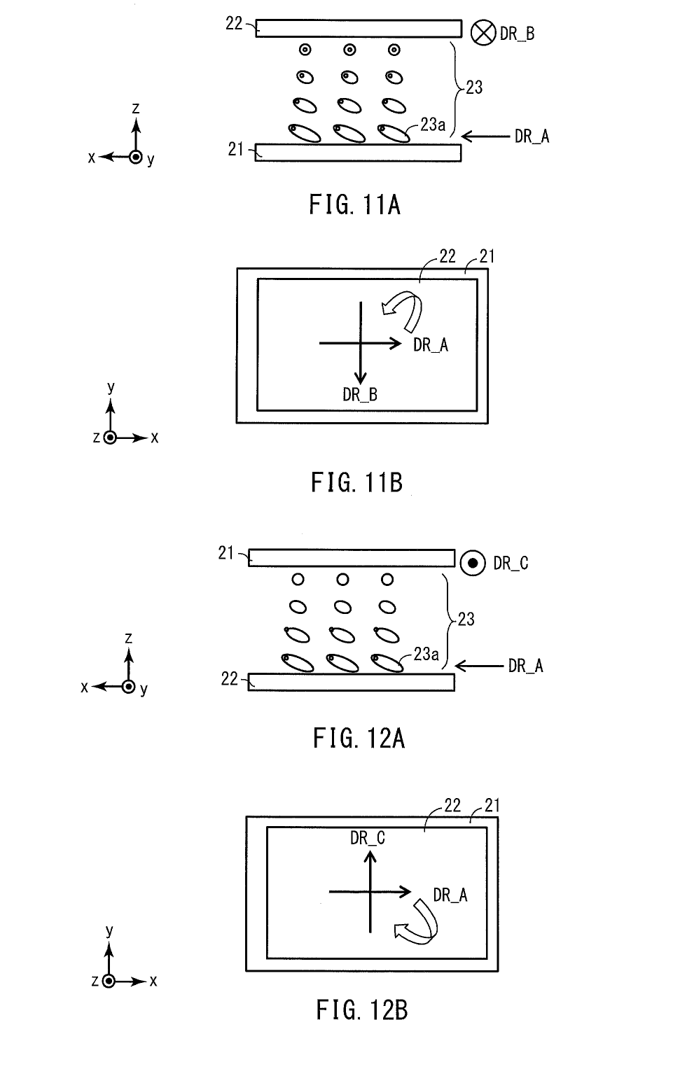

Liquid crystal molecules of twisted nematic liquid crystal can be twisted clockwise or counterclockwise, regarding a twist direction thereof. Here, “clockwise twist” and “counterclockwise twist” are defined with reference to FIGS. 11A, 11B, 12A, and 12B. FIGS. 11A and 12A schematically illustrate a state in which liquid crystal molecules 23a in the liquid crystal layer 23 are twisted, in a region from the first substrate 21 to the second substrate 22. In FIGS. 11A and 12A, circle marks are put on ends of the liquid crystal molecules 23a on one side in the major axis direction, so that the orientations of the liquid crystal molecules 23a can be recognized clearly.

FIG. 11A illustrates a case where the alignment film of the first substrate 21 is rubbed in the rubbing direction DR_A, which is toward the plus side of the x direction, and the alignment film of the second substrate 22 is rubbed in the rubbing direction DR_B, which is toward the minus side of the y direction. FIG. 11B is a plan view illustrating the relationship between the rubbing direction DR_A and the rubbing direction DR_B as viewed from the viewer side. The void arrow in FIG. 11B indicates the rotation direction of the liquid crystal molecules 23a in a region from the first substrate 21 to the second substrate 22 as viewed from the viewer side.

To the liquid crystal molecules 23a, a pre-tilt is imparted by a rubbing treatment. In other words, as illustrated in FIG. 11A, the liquid crystal molecules 23a rise toward the rubbing direction. In the case of FIG. 11A, the liquid crystal molecules on the first substrate 21 side rise toward the plus side of the x direction, and the liquid crystal molecules on the second substrate 22 side rise toward the minus side of the y direction. The liquid crystal molecules 23a, therefore, are twisted clockwise as viewed from the light source side. The clockwise rotation of the molecule major axis of the liquid crystal molecule as viewed from the light source side as going from the substrate on the light incident side toward the substrate on the light exit side is defined as “clockwise twist”.

FIG. 12A illustrates a case where the alignment film of the first substrate 21 is rubbed in the rubbing direction DR_A, toward the plus side of the x direction, and the alignment film of the second substrate 22 is rubbed in the rubbing direction DR_C, toward the plus side of the y direction. FIG. 12B is a plan view illustrating the relationship between the rubbing direction DR_A and the rubbing direction DR_C as viewed from the viewer side. The void arrow in FIG. 11B indicates the rotation direction of the liquid crystal molecules 23a in a region from the first substrate 21 to the second substrate 22 as viewed from the viewer side.

In the case of FIG. 12A, the liquid crystal molecules on the first substrate 21 side rise toward the plus side of the x direction, and the liquid crystal molecules on the second substrate 22 side rise toward the plus side of the y direction. The liquid crystal molecules 23a, therefore, are twisted counterclockwise as viewed from the light source side. The counterclockwise rotation of the molecule major axis of the liquid crystal molecule as viewed from the light source side as going from the substrate on the light incident side toward the substrate on the light exit side is defined as “counterclockwise twist”.

In this way, the twist direction of the liquid crystal molecules is determined by the rubbing direction of the first substrate 21 and the rubbing direction of the second substrate 22. To the liquid crystal layer 23, a chiral material according to the twist direction is added so that a reverse tilt that causes alignment defects should be suppressed.

As illustrated in FIGS. 9 and 10, the present embodiment is configured so that the twist direction of liquid crystal molecules is the counterclockwise twist direction. In addition to this, a chiral material for counterclockwise twist is preferably added to the liquid crystal layer 23.

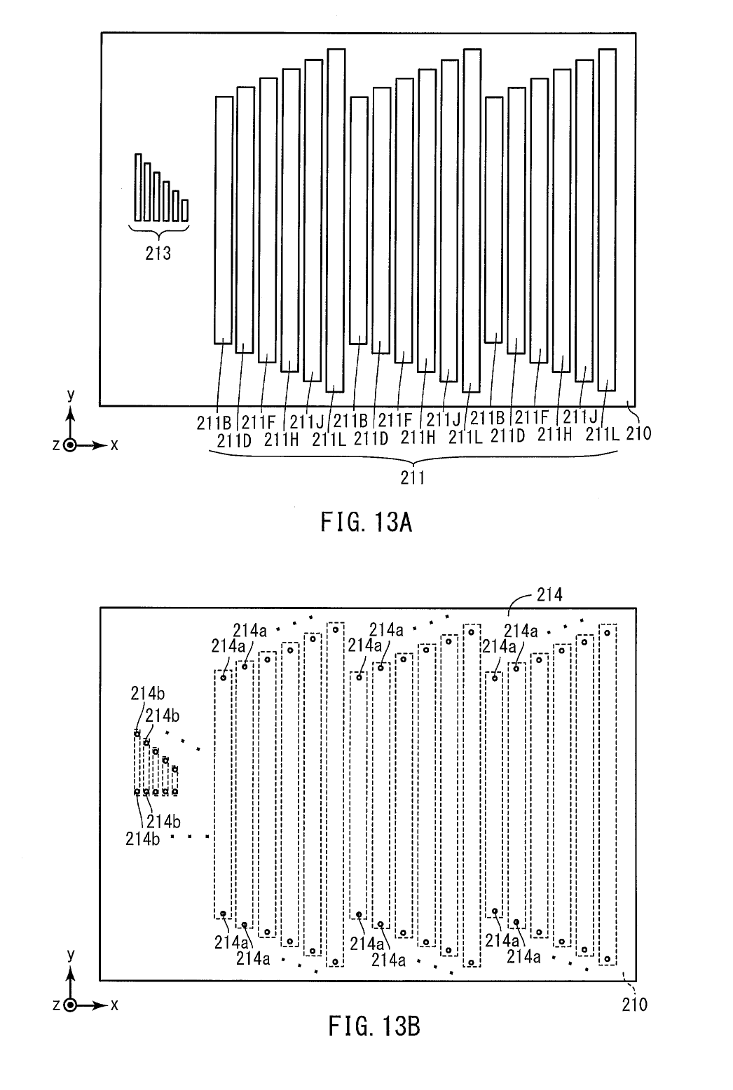

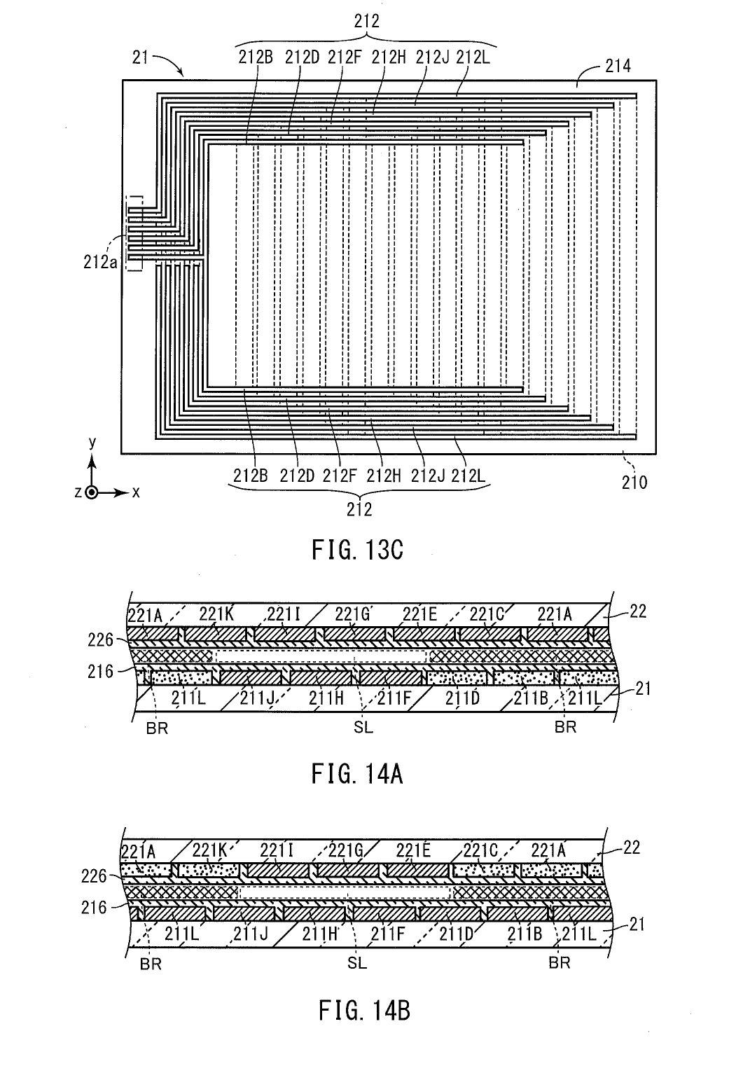

Hereinafter, an exemplary specific configuration of the first substrate 21, and a method for producing the same, are described, with reference to FIGS. 13A to 13C. The second substrate 22 may have a configuration identical to that of the first substrate 21, and may be produced in the same manner as that for the first substrate 21.

First of all, as illustrated in FIG. 13A, the first electrode group 211 and relay electrodes 213 are formed on the substrate 210. The relay electrodes 213 are electrodes for relaying the line group 212 that is to be formed in a later step. The substrate 210 is a substrate that has translucency and insulation properties, for example, a glass substrate. The first electrode group 211 preferably has translucency. In a case where the relay electrodes 213 are formed in the active area, the relay electrodes 213 preferably have translucency as well. On the other hand, in a case where the relay electrodes 213 are formed outside the active area, the relay electrodes 213 are not required to have translucency. The first electrode group 211 and the relay electrodes 213 are made of, for example, indium tin oxide (ITO). In the case where the relay electrodes 213 are formed outside the active area, the relay electrodes 213 may be made of, for example, aluminum. The first electrode group 211 and the relay electrodes 213 are formed by the following process, for example: films are formed by sputtering or chemical vapor deposition (CVD), and are patterned by photolithography.

Next, as illustrated in FIG. 13B, an insulating film 214 is formed so as to cover the substrate 210, the first electrode group 211, and the relay electrodes 213. In the insulating film 214, contact holes 214a and contact holes 214b are formed. The contact holes 214a are formed at such positions as to allow the first electrode group 211 and the line group 212, which is to be formed in the next step, to be connected with each other. The contact holes 214b are formed at such positions as to allow the relay electrodes 213 and the line group 212 to be connected with each other.

The insulating film 214 preferably has translucency, and is made of, for example, SiN. The insulating film 214, for example, is formed with a film formed by CVD, and the contact holes 214a and the contact holes 214b are formed therein by photolithography. In a case where the line group 212 is formed outside the active area, the patterning may be performed in such a manner that the insulating film 214 is formed only outside the active area.

Next, as illustrated in FIG. 13C, the line group 212 is formed. The line group 212 is connected via the contact holes 214a to the first electrode group 211, and is connected via the contact holes 214b to the relay electrodes 213. The line group 212 preferably has high conductivity, and is made of, for example, aluminum. The line group 212 may be made of ITO. The line group 212 is formed by the following process, for example: a film is formed by sputtering, and is patterned by photolithography.

As described above, the electrodes 211B, 211D, 211F, 211H, 211J, and 211L are connected with the lines 212B, 212D, 212F, 212H, 212J, and 212L, respectively. With this three-layer configuration of the first electrode group 211, the insulating layer 214, and the line group 212, the first electrode group 211 and the line group 212 are caused to intersect as viewed in a plan view.

In the example illustrated in FIG. 13C, ends on one side of the line group 212 are gathered in the vicinities of a peripheral part of the substrate 21, and form a terminal part 212a. To the terminal part 212a, a flexible printed circuit (FPC) and the like is connected.

In the example illustrated in FIG. 13C, lines are connected to ends on both sides in the y direction of each electrode of the electrode group 211. The pair of lines connected to ends on both sides in the y direction of each electrode of the electrode group 211 are connected with each other by the relay electrodes 213. By applying a signal from both ends in the y direction of each electrode of the electrode group 211, a potential difference in the inside of each electrode can be reduced.

### [Method for Driving Switch Liquid Crystal Panel 20]

Next, a method for driving the switch liquid crystal panel 20 is described with reference to FIGS. 14A and 14B.

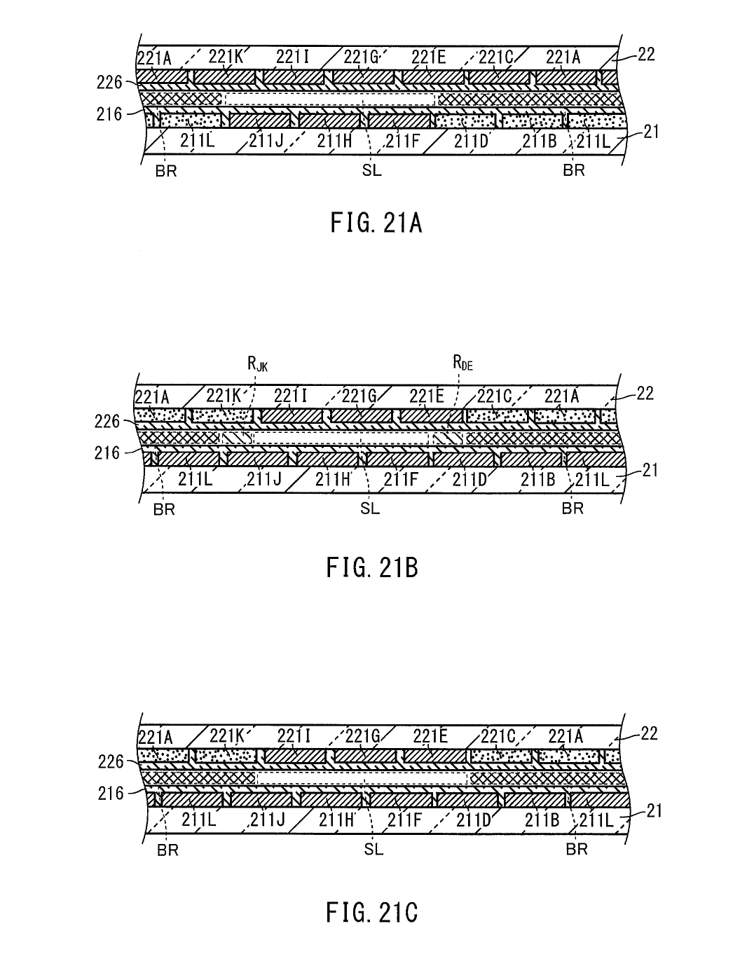

FIG. 14A is a cross-sectional view schematically illustrating one barrier lighting state to be displayed on the switch liquid crystal panel 20. The control unit 40 (FIG. 2) causes the polarity of a part of electrodes included in one electrode group selected from the first electrode group 211 and the second electrode group 221, and the polarity of the other electrodes, to be opposite to each other. FIG. 14A schematically illustrates electrodes having a different polarity, by indicating the same with a sandy pattern. The same indication is used in FIG. 14B, as well as FIGS. 21A to 21C and FIG. 28 to be referred to below.

In the example illustrated in FIG. 14A, electrodes 211B, 211D, and 211L included in the second electrode group 211, and the other electrodes (the electrodes 211F, 211H, 211J, and 221A to 221K) are caused to have opposite polarities, respectively.

This allows a potential difference to occur between the electrode 221A and the electrode 211B, thereby causing the liquid crystal molecules of the liquid crystal layer 23 therebetween to be aligned in the z direction. The switch liquid crystal panel 20 is normally white liquid crystal. Therefore, the barrier BR is formed in a portion where the electrode 221A and the electrode 211B overlap as viewed in a plan view (the xy plan view).

Similarly, the barriers BR are formed in portions where the electrode 211B and the electrode 221C overlap, the electrode 221C and the electrode 211D overlap, the electrode 211D and the electrode 221E overlap, the electrode 221K and the electrode 211L overlap, and the electrode 211L and the electrode 221A overlap, as viewed in the plan view.

On the other hand, no potential difference occurs to between the electrode 221E and the electrode 211F. As described above, the switch liquid crystal panel 20 is normally white liquid crystal. Therefore, the slit SL is formed in a portion where the electrode 221E and the electrode 211F overlap as viewed in the plan view.

Similarly, the slits SL are formed in portions where the electrode 211F and the electrode 221G overlap, the electrode 221G and the electrode 211H overlap, the electrode 211H and the electrode 221I overlap, the electrode 221I and the electrode 211J overlap, as well as the electrode 211J and the electrode 221K overlap, as viewed in a plan view.

As a result, the barrier BR is formed in a portion that overlaps the electrodes 211B, 211D, and 211L, as viewed in a plan view, and the slit SL is formed in a portion that overlaps the electrodes 211F, 211H, and 211J as viewed in a plan view.

FIG. 14B is a cross-sectional view schematically illustrating another barrier lighting state to be displayed on the switch liquid crystal panel 20. FIG. 14B also schematically illustrates electrodes having a different polarity, by indicating the same with a sandy pattern.

In the example illustrated in FIG. 14B, electrodes 221A, 221C, 221K included in the second electrode group 221, and the other electrodes (the electrodes 221E, 221G, 221I, and 211B to 211L) are caused to have opposite polarities, respectively.

This causes a barrier BR to be formed in a portion that overlaps the electrodes 221A, 221C, and 221K as viewed in a plan view, and causes a slit SL to be formed in a portion that overlaps the electrodes 221E, 221G, and 221I as viewed in a plan view.

As is clear from comparison between FIG. 14A and FIG. 14B, with this configuration of the switch liquid crystal panel 20, the barrier lighting state can be controlled using half of the electrode interval BP as a minimum unit.

### [Configuration of Pixel 110 of Display Panel 10]

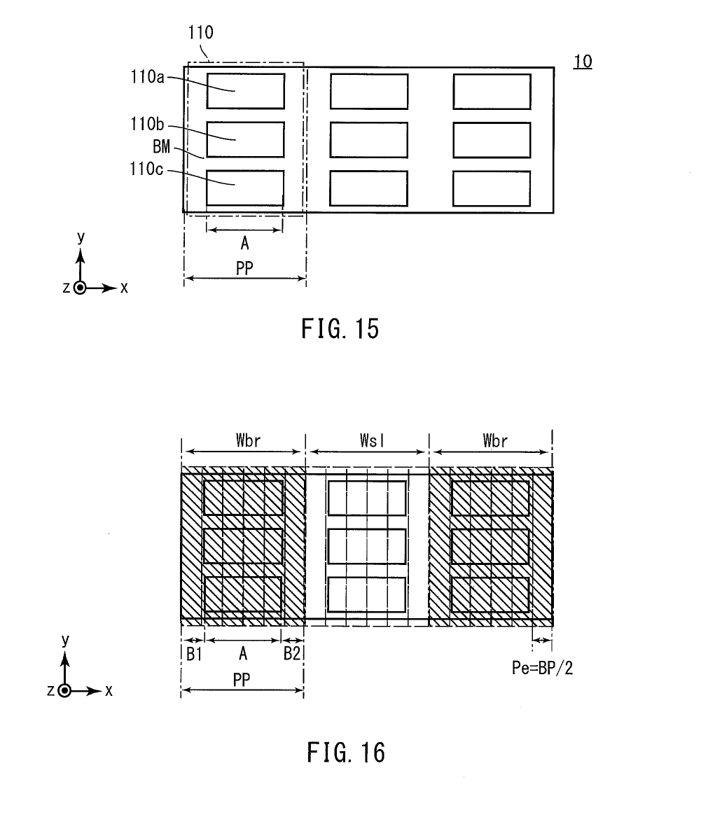

FIG. 15 is a plan view for explaining a configuration of a pixel 110 of a display panel 10. The pixel 110 includes three subpixels 110a, 110b, and 110c arranged in the y direction, and a black matrix BM formed between the same. The subpixels 110a, 110b, and 110c display, for example, red, green, and blue, respectively. The black matrix BM blocks light from a backlight, so as to improve contrast in the display panel 10.

FIG. 16 schematically illustrates the relationship between the pixels 110 and the barriers BR as well as the slits SL formed by the switch liquid crystal panel 20. FIG. 16 indicates the barriers BR by hatching the same.

As illustrated in FIG. 16, the width of the barrier BR is given as “Wbr”, and the width of the slit SL is given as “Wsl”. Besides, the minimum unit (barrier switching pitch) with which the barrier lighting state can be controlled is given as “Pe”. As mentioned above, in the present embodiment, the barrier switching pitch Pe is equal to half of the electrode pitch BP.

In the present embodiment, the barrier lighting state of the switch liquid crystal panel 20 is controlled so that Wbr-Wsl is satisfied.

The width of the opening of the pixel 110 in the barrier BR alignment direction (x direction) is given as “A”. “B1” and “B2” represent the widths of the black matrix BM, and satisfy PP=A+B1+B2. Here, Wsl, Wbr, A, and Pe satisfy the following formulae (1) and (2):

A≦Wsl−2Pe (1)

A≦Wbr−2Pe (2)

### [Effects of Stereoscopic Display Device 1]

Hereinafter, effects of the stereoscopic display device 1 according to the present embodiment are described.

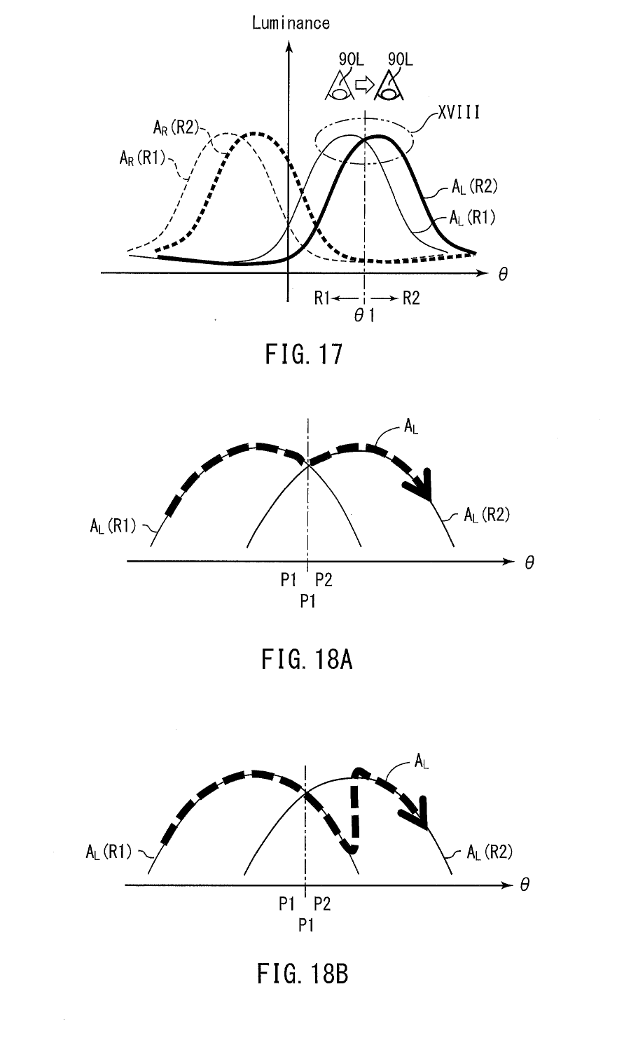

FIG. 17 schematically illustrates angle characteristics of luminance of the stereoscopic display device 1. A_{L} (R1) and A_{L} (R2) indicate angle characteristics of luminance when a white image (bright image) is displayed as a left-eye image, and a black image (dark image) is displayed as a right-eye image on the display panel 10. A_{R} (R1) and A_{R} (R2) indicate angle characteristics of luminance when a white image (bright image) is displayed as a right-eye image, and a black image (dark image) is displayed as a left-eye image on the display panel 10.

The stereoscopic display device 1 switches the barrier lighting state of the switch liquid crystal panel 20 when a viewer moves from an area R1 to an area R2. A_{L} (R1) and A_{R} (R1) indicate luminance characteristics before the barrier lighting state is switched, that is, when a viewer is in the area R1. A_{R} (R1) and A_{R} (R2) indicate luminance characteristics after the barrier lighting state is switched, that is, when a viewer is in the area R2. In the example illustrated in FIG. 17, the stereoscopic display device 1 switches the barrier lighting state, when an angle θ formed between the normal line of the stereoscopic display panel and a line section extending from the center of the stereoscopic display panel 10 to the center of the left and right eyes becomes equal to or greater than a predetermined threshold value θ1 that determines a boundary between the area R1 and the area R2.

FIGS. 18A and 18B are enlarged views of a portion surrounded by an alternate long and two short dashed line XVIII in FIG. 17. FIG. 18A schematically illustrates luminance variation in a case where a viewer relatively slowly moved. FIG. 18B schematically illustrates luminance variation in a case where a viewer relatively quickly moved.

As described with reference to FIG. 3, the switching of the barrier lighting state is performed by the following steps: the position sensor 41 (FIG. 2) acquires viewer position information (Step S1); the computing unit 42 (FIG. 2) calculates position information (Step S2); the computing unit 42 determines a barrier lighting state (Step S3); and the switch liquid crystal panel driving part 43 (FIG. 2) drives the switch liquid crystal panel 20 (Step S4). The calculation of the position information by the computing unit 42 (FIG. 2) (Step S2) includes, for example, face recognition and eye position coordinate detection by an eye tracking system.

Time spent for these steps causes delay in the switching of the barrier lighting state in some cases. When a viewer quickly moves, this delay affects the display quality of the stereoscopic display device in some cases.

As illustrated in FIG. 18A, in the case where a viewer relatively slowly moves, the switching of the barrier lighting state completes in the vicinities of the boundary between the area R1 and the area R2. Luminance variation is therefore small.

On the other hand, as illustrated in FIG. 18B, in the case where a viewer relatively quickly moves, the switching of the barrier lighting state is performed at a position far from the boundary between the area R1 and the area R2 due to the above-mentioned delay. Luminance variation is therefore large.

To reduce this luminance variation, the delay in the switching of the barrier lighting state is preferably reduced. In order to reduce the delay in the switching of the barrier lighting state, the speed in Steps S1 to S4 is preferably made faster. There is, however, a limit to making the speed in Steps S1 to S4 faster, and it is difficult to respond to every quick motion of a viewer. Further, it is difficult to control the speed for driving the switch liquid crystal panel 20 (Step S4), since the response properties of the liquid crystal vary with the ambient temperature.

It is therefore more preferable to reduce luminance variation even if a delay occurs to the switching of the barrier lighting state. More specifically, by flattening the luminance characteristics, luminance variation can be reduced. For example, it is preferable to cause each of A_{L} (R1), A_{R} (R1), A_{L} (R2) and A_{R} (R2) (FIG. 17) to become a curve having a flat vertex and a large width.

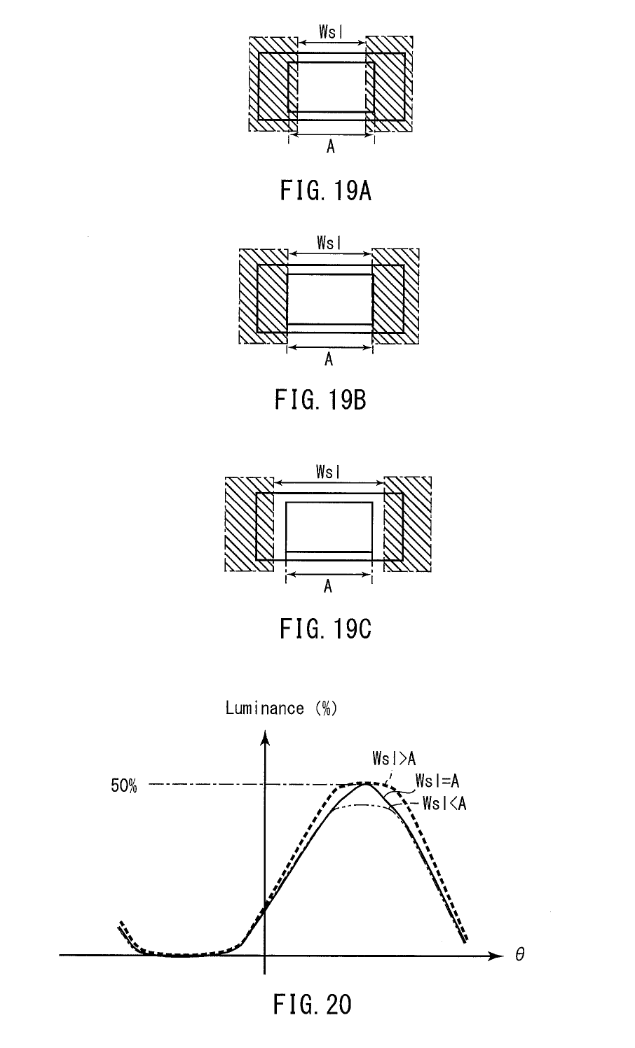

Here, the relationship between the width Wsl of a slit and angle characteristics of luminance is described. FIGS. 19A to 19C schematically illustrate the relationship between the width A of the opening of the pixel in the alignment direction of the barriers, and the width Wsl of the slit. FIG. 19A illustrates a case where the width Wsl of the slit is smaller than the width A of the opening, FIG. 19B illustrates a case where the width Wsl of the slit is equal to the width A of the opening, and FIG. 19C illustrates a case where the width Wsl of the slit is greater than the width A of the opening.

FIG. 20 schematically illustrates angle characteristics of luminance when the width of the slit Wsl is changed. When the width Wsl of the slit is smaller than the width A of the opening (Wsl<A), the luminance characteristics becomes flat, but the maximum luminance becomes less than 50%. On the other hand, when the width Wsl of the slit is equal to the width A of the opening (Wsl=A), the maximum luminance becomes 50%, but the distribution thereof becomes steep. When the width Wsl of the slit is larger than the width A of the opening (Wsl>A), the luminance characteristics become flat, and the maximum luminance becomes 50%.

As illustrated in FIG. 16, in the stereoscopic display device 1 according to the present embodiment, the width Wsl of the slit is greater than the width A of the opening. The luminance characteristics of the stereoscopic display device 1 are flat, and the maximum luminance is 50%.

Next, luminance variation that occurs according to the response speed of the liquid crystal is described, with reference to FIGS. 21A to 21C. This luminance variation occurs in some cases even in a case where a viewer relatively slowly moves.

FIGS. 21A to 21C are cross-sectional views schematically illustrating state before and after the barrier lighting state is moved by one unit. More specifically, FIG. 21A illustrates a state before the barrier lighting state is switched, FIG. 21B illustrates a state during the switching of the barrier lighting state, and FIG. 21C illustrates a state after the barrier lighting state is switched.

In FIG. 21A, the barriers BR are formed in portions that overlap the electrode 211B, 211D, and 211L as viewed in a plan view, and the slit SL is formed in a portion that overlaps the electrodes 211F, 211H, and 211J as viewed in a plan view. In FIG. 27C, barriers BR are formed in portions that overlap the electrodes 221A, 221C, and 221K as viewed in a plan view, and a slit SL is formed in a portion that overlaps the electrodes 221E, 221G, and 221I as viewed in a plan view.

As illustrated in FIG. 21B, during the switching from the state in FIG. 21A to the state in FIG. 21C, in an area RDE that overlaps the electrodes 211D and 221E as viewed in a plan view, the switching occurs from the barrier BR to the slit SL. Similarly, in an area RJK that overlaps the electrodes 211J and 221K as viewed in a plan view, the switching occurs from the slit SL to the barrier BR. In other words, when the barrier lighting state is switched, a portion in a size twice the barrier switching pitch Pe operates.

The response speed of liquid crystal when the voltage applied to the liquid crystal layer 23 decreases is slower as compared with the response speed of liquid crystal when the voltage applied to the liquid crystal layer 23 increases. This is because the response speed of liquid crystal when the applied voltage decreases is determined principally depending on the physical properties of the liquid crystal and the thickness of the liquid crystal layer, and it is difficult to control the same. The time necessary for the switching of the area RDE from the barrier BR to the slit SL is longer than the time necessary for the switching of the area RJK from the slit SL to the barrier BR. In the state illustrated in FIG. 21B, therefore, the width of the slit SL temporarily becomes narrower. This causes luminance variation in some cases.

It is possible to, for example, drive the backlight by pulse width modulation so as to make correction to cancel the luminance variation, or to adjust the liquid crystal driving voltage timing so as to reduce the luminance variation. This luminance variation, however, is different depending on the viewer position and the ambient temperature, and this makes the correction parameters complicated. For this reason, it is preferable to provide such a configuration that luminance variation does not occur even if there is a difference in the response speed of the liquid crystal layer 23 between the area RDE and the area R_{JK}.

As described above, in the present embodiment, the width Wsl of the slit, the width Wbr of the barrier, the width A of the opening, and the barrier switching pitch Pe satisfy the formulae (1) and (2). More specifically, the width A of the opening is equal to or less than a value determined by subtracting the width of liquid crystal that operates during the switching of the barrier lighting state (the width twice the barrier switching pitch Pe) from the width Wsl of the slit. Besides, the width A of the opening is equal to or less than a value determined by subtracting the width of liquid crystal that operates during the switching of the barrier lighting state (the width twice the barrier switching pitch) from the width Wbr of the barrier.

With this configuration, over a period before and after the switching of the barrier lighting state, pixels to be displayed are by no means shielded by the barriers BR. Further, over a period before and after the switching of the barrier lighting state, pixels to be shielded by the barriers BR are by no means displayed. This makes it possible to prevent luminance variation from occurring before and after the switching of the barrier lighting state. According to the present embodiment, therefore, luminance variation occurring depending on the response speed of liquid crystal can be suppressed as well.

In the present embodiment, further, the width Wsl of the slit and the width Wbr of the barrier are set to be equal to each other. When the width Wsl of the slit and the width Wbr of the barrier are equal to each other, the width A of the opening that satisfies the formulae (1) and (2) can be maximized.

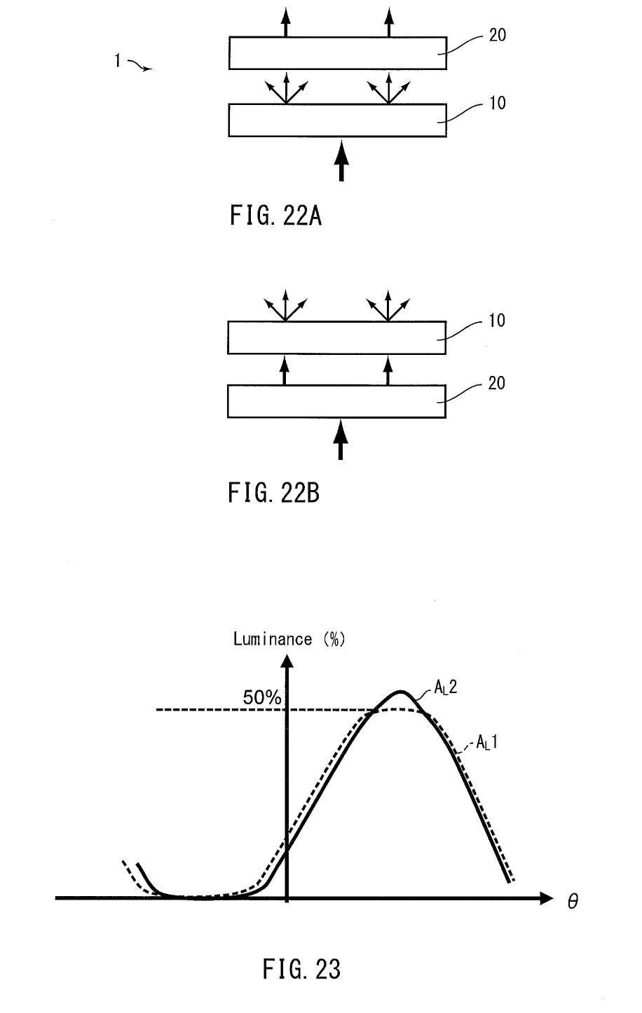

Next, the relationship between the arrangement of the switch liquid crystal panel 20 and the display quality of the stereoscopic display device 1 is described, with reference to FIGS. 22A and 22B. FIG. 22A schematically illustrates behavior of light in a case where the switch liquid crystal panel 20 is arranged on a viewer side with respect to the display panel 10 (the front barrier type), as is the case with the stereoscopic display device 1 according to the present embodiment. FIG. 22B schematically illustrates behavior of light in a case where the display panel 10 is arranged on a viewer side with respect to the switch liquid crystal panel 20 (the rear barrier type).

In the case of the rear barrier type, light having passed through the switch liquid crystal panel 20 passes through the display panel 10. In the case of the rear barrier type, diffusion and diffraction of light occurs inside the display panel 10, which deteriorates separation properties. On the other hand, in the case of the front barrier type, light having passed through the display panel 10 is separated by the switch liquid crystal panel 20. The front barrier type, therefore, has higher separation properties as compared with the rear barrier type, thereby being capable of reducing crosstalk.

The stereoscopic display device 1 according to the present embodiment is of the front barrier type, as described above. The stereoscopic display device 1, therefore, is capable of displaying stereoscopic images with low crosstalk.

On the other hand, in the case of the front barrier type, the following problem occurs. Liquid crystal molecules of the liquid crystal layer 23 of the switch liquid crystal panel 20 have refractive index anisotropy. At the boundary between the slit and the barrier, therefore, the liquid crystal layer 23 works as a lens in some cases.

FIG. 23 schematically illustrates luminance characteristics AL1 in a case where a lens effect is not taken into consideration, and luminance characteristics AL2 in a case where a lens effect is taken into consideration. As illustrated in FIG. 23, as indicated by the luminance characteristics AL2, light is gathered by the liquid crystal layer 23, whereby greater brightness is obtained as compared with the case where there is no lens effect. In the case of the front barrier type, therefore, even if the width Wsl of the slit>the width A of the opening is satisfied, the luminance characteristics do not become flat. Besides, the magnitude of the lens effect varies depending on the magnitude of the width Wsl of the slit.

In the stereoscopic display device 1 according to the present embodiment, the rubbing direction is aligned with the transmission axis of the polarizing plate. In other words, as illustrated in FIG. 10, the transmission axis of the polarizing plate 15 and the rubbing direction DR1 are arranged so as to be parallel to each other, and the transmission axis of the polarizing plate 24 and the rubbing direction DR2 are arranged so as to be parallel to each other. According to this configuration, in a case where the rubbing direction is aligned with the absorption axis of the polarizing plate, in other words, in a case where the absorption axis of the polarizing plate 15 and the rubbing direction DR1 are arranged so as to be parallel to each other, the lens effect can be suppressed better, as compared with a case where the absorption axis of the polarizing plate 24 and the rubbing direction DR2 are arranged so as to be parallel to each other.

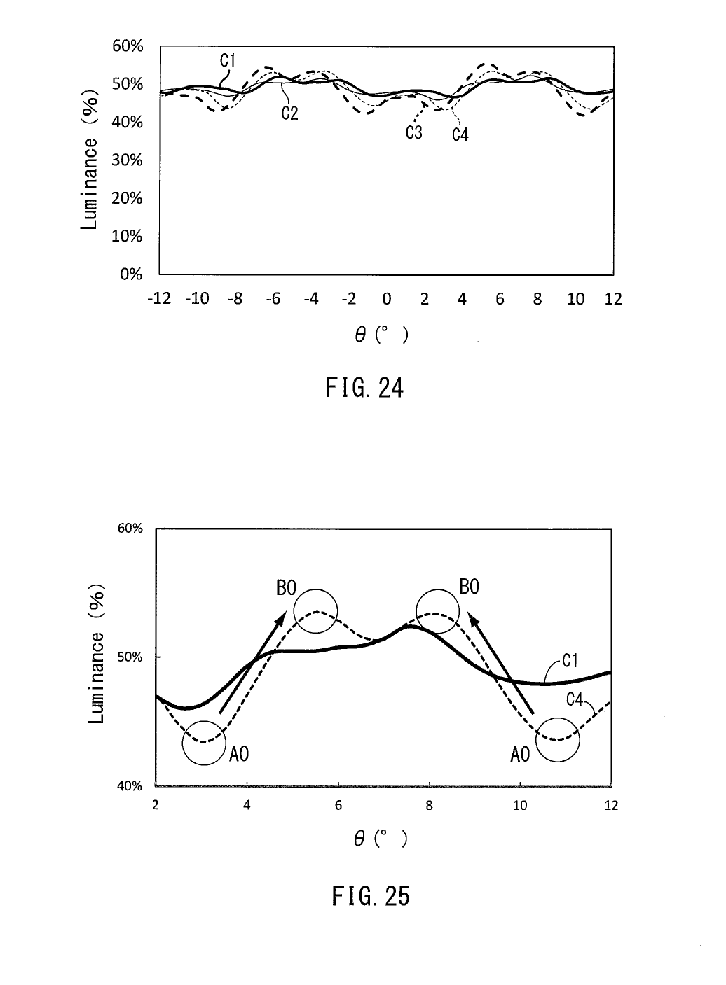

FIG. 24 illustrates luminance characteristics when the rubbing directions for the alignment films of the first substrate 21 and the second substrate 22 are varied. The curve C1 (thick solid line) indicates luminance characteristics in a case where the rubbing axis is aligned with the transmission axis and the twist direction of the liquid crystal molecules is a counterclockwise twist direction. The curve C2 (thin solid line) indicates luminance characteristics in a case where the rubbing axis is aligned with the transmission axis and the twist direction of the liquid crystal molecules is a clockwise twist direction. The curve C3 (thick broken line) indicates luminance characteristics in a case where the rubbing direction is aligned with the absorption axis of the polarizing plate and the twist direction of the liquid crystal molecules is a counterclockwise twist direction. The curve C4 (thin broken line) indicates luminance characteristics in a case where the rubbing axis is aligned with the absorption axis and the twist direction of the liquid crystal molecules is a clockwise twist direction.

FIG. 25 is a view obtained by focusing on and enlarging the curves C1 and C4 illustrated in FIG. 24. As illustrated in FIG. 25, regarding the curve C4, portions thereof denoted by the reference symbol A0 in the drawing indicate lower luminance, and portions thereof denoted by the reference symbol B0 in the drawing indicate higher luminance. In other words, light in an area corresponding to the portion of A0 is gathered to an area corresponding to the portion of B0. On the other hand, the curve C1 is relatively flat. This means that the lens effect is suppressed.

As illustrated in FIG. 24, in the case where the rubbing axis is aligned with the transmission axis (C1, C2), the lens effect can be suppressed as compared with the case where the rubbing direction is aligned with the absorption axis of the polarizing plate (C3, C4).

The stereoscopic display device 1 according to the present embodiment is further configured so that the twist direction of the liquid crystal molecules is a counterclockwise twist direction. The comparison between the curves C1, C3 and the curves C2, C4 in FIG. 24 proves that the lens effect can be suppressed better in the case where the twist direction of the liquid crystal molecules is a counterclockwise twist direction (C1, C3), as compared with the case where the twist direction of the liquid crystal molecules is the clockwise twist direction (C2, C4).

The configuration of the stereoscopic display device 1 according to Embodiment 1 of the present invention is described above. As mentioned above, in the stereoscopic display device 1, the switch liquid crystal panel 20 is arranged on the viewer side with respect to the display device 10, whereby separation properties are improved, and the display quality of stereoscopic images is enhanced. In the stereoscopic display device 1, the width Wsl of the slit of the parallax barrier is set greater than the width A of the opening, whereby the luminance characteristics are flattened. The stereoscopic display device 1 has the following configurations: (A) the twist direction of the liquid crystal molecules is a counterclockwise twist direction; and (B) the rubbing direction is aligned with the transmission axis of the polarizing plate. The stereoscopic display device 1, with these configurations, suppresses the lens effect of the liquid crystal layer 23, and further flattens the luminance characteristics.

Even with either one of the configurations (A) and (B) alone, the effect of suppressing the lens effect can be achieved. In a case where the configuration (B) alone is adopted, the rubbing direction and the transmission axis of the polarizing plate may form an angle therebetween other than being parallel or orthogonal to each other.

As the present embodiment, the case where the rubbing direction of the alignment film 216 and the rubbing direction of the alignment film 226 forms an angle of 90° is described, but the angle formed between the rubbing direction of the alignment film 216 and the rubbing direction of the alignment film 226 may be other than 90°. Further, as the present embodiment, the case where the rubbing direction of the alignment film 216 is tilted at 63° and the rubbing direction of the alignment film 226 is tilted at 153° is described, but these angles are arbitrary as long as either one of the configurations (A) and (B) described above is satisfied.

As the present embodiment, the configuration in which the parallax barrier is moved according to the viewer position information is described, but the effect of suppressing the lens effect is valid even in a case where the parallax barrier is fixed.

According to the present embodiment, the width Wsl of the slit, the width Wbr of the barrier, the width A of the opening, and the barrier switching pitch Pe satisfy the formulae (1) and (2). This prevents luminance variation from occurring, even in a case where there are differences in the response speed of the liquid crystal layer 23. In a case where there is no difference in the response speed of the liquid crystal layer 23, a case where correction can be made by another method, or the like, this configuration does not have to be adopted.

As the present embodiment, a case where the first electrode group 211 and the second electrode group 221 are composed of electrodes of 12 types in total is described. This configuration is merely an example, and the number of electrodes composing the first electrode group 211 and the second electrode group is arbitrary.

### Embodiment 2

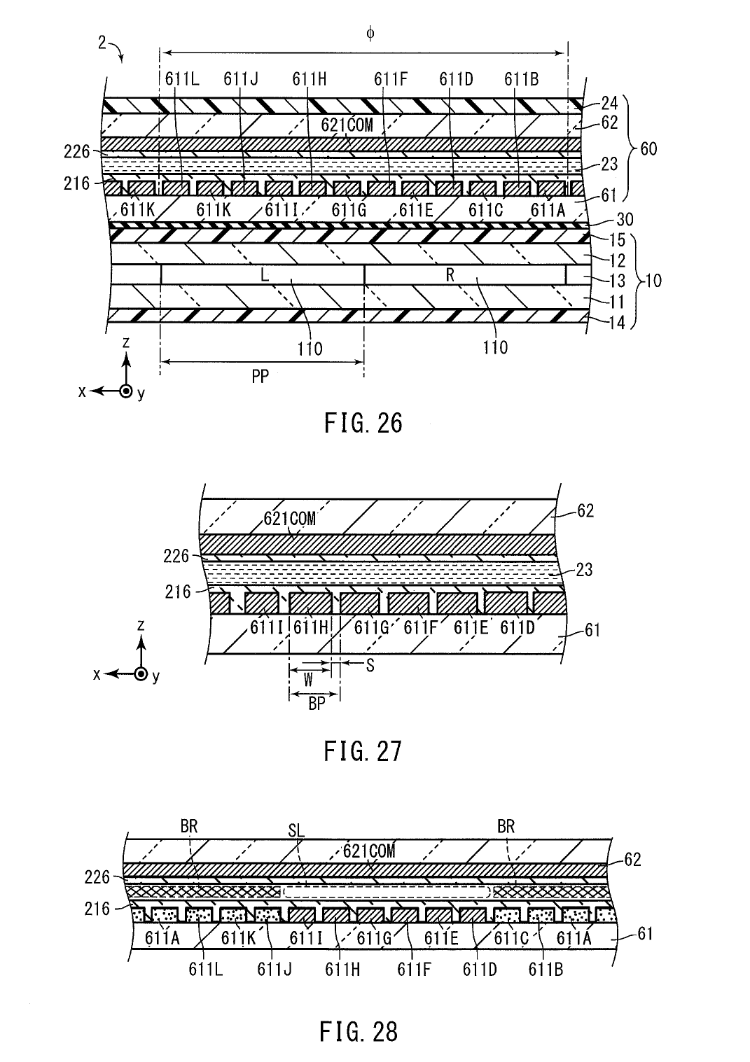

FIG. 26 is a cross-sectional view illustrating a schematic configuration of a stereoscopic display device 2 according to Embodiment 2 of the present invention. The stereoscopic display device 2 includes a switch liquid crystal panel 60 in place of the switch liquid crystal panel 20.

The switch liquid crystal panel 60 includes a first substrate 61 in place of the first substrate 21 of the switch liquid crystal panel 20, and includes a second substrate 62 in place of the second substrate 22.

On the first substrate 61, electrodes 611A to 611L, to which signals of 12 systems, i.e., signals V_{A} to V_{L}, are supplied, are formed. The electrodes 611A to 611L, as is the case with the electrodes 211B to 211K of the first substrate 21, are formed in periodic fashion in the x direction. On the second substrate 62, a common electrode 621COM is formed so as to cover a substantially entire surface of an active area of the second substrate 62. To the common electrode 621COM, a signal V_{COM} is supplied.

FIG. 27 is an enlarged cross-sectional view of a part of the switch liquid crystal panel 60. In the present embodiment, the configuration is such that BP=φ/12≈PP/6 is satisfied. It should be noted that, as will be described later, the barrier switching pitch Pe becomes equal to BP. A more specific example of the configuration is, for example, as follows: the pixel pitch PP of the display panel 10 is 96 μm, the electrode pitch BP is approximately 16 μm, the width W of the electrode is 12 μm, the clearance between the electrodes S is 4 μm, and the barrier switching pitch Pe is approximately 16 μm.

The switch liquid crystal panel 60, as is the case with the switch liquid crystal panel 20, is twisted nematic liquid crystal, and is normally white liquid crystal. In the switch liquid crystal panel 60 further, as is the case with the switch liquid crystal panel 20, the twist direction of the liquid crystal molecules is a counterclockwise twist direction, and further, the rubbing direction is aligned with the transmission axis of the polarizing plate.

In the present embodiment as well, the width Wsl of the slit, the width Wbr of the barrier, the width A of the opening, and the barrier switching pitch Pe satisfy the formulae (1) and (2).

### [Method for Driving Switch Liquid Crystal Panel 60]

FIG. 28 is a cross-sectional view schematically illustrating one barrier lighting state of the switch liquid crystal panel 60. In the switch liquid crystal panel 60, the polarity of the common electrode 621COM and the electrodes 611D to 611I, and the polarity of the other electrodes, are opposite to each other.

In the example illustrated in FIG. 28, rectangular alternating-current voltages having polarities opposite to each other are applied to the common electrode 621COM and the electrodes 611D to 611I, and the other electrodes, respectively.

This allows a potential difference to occur between the common electrode 621COM and the electrode 611A, thereby causing liquid crystal molecules of the liquid crystal layer 23 between the common electrode 621COM and the electrode 611A to be aligned in the z direction. As described above, the switch liquid crystal panel 60 is normally white liquid crystal. Therefore, the barrier BR is formed in a portion where the common electrode 621COM and the electrode 611A overlap as viewed in a plan view (the xy plan view).

Similarly, the barriers BR are formed in portions where the common electrode 621COM and the electrode 611B overlap, the common electrode 621COM and the electrode 611C overlap, the common electrode 621COM and the electrode 611J overlap, the common electrode 621COM and the electrode 611K overlap, and the common electrode 621COM and the electrode 611L overlap, as viewed in a plan view.

On the other hand, no potential difference occurs between the common electrode 621COM and the electrodes 611D to 611I. As described above, the switch liquid crystal panel 20 is normally white liquid crystal. Therefore, a slit SL is formed in a portion where the common electrode 621COM and the electrodes 611D to 611I overlap as viewed in a plan view.

In this way, the slit SL is formed at a position that overlaps the electrodes having the same polarity as that for the common electrode 621COM as viewed in a plan view, and the barrier BR is formed at a position that overlaps the other electrodes as viewed in a plan view.

According to the present embodiment, the barrier lighting state can be controlled by using the electrodes 611A to 611L as units. In other words, the barrier lighting state can be controlled by using the electrode interval BP as a minimum unit. In other words, the barrier switching pitch Pe becomes equal to the electrode pitch BP.

The foregoing description describes the configuration of the stereoscopic display device 2 according to Embodiment 2 of the present invention.

In the stereoscopic display device 2 as well, by arranging the switch liquid crystal panel 60 on the viewer side with respect to the display device 10, the separation properties are improved, and the display quality of the stereoscopic images is enhanced. In the stereoscopic display device 2, the width Wsl of the slit of the parallax barrier is set to be greater than the width A of the opening, whereby the luminance characteristics are flattened. In the stereoscopic display device 2, the twist direction of the liquid crystal molecules is a counterclockwise twist direction, and the rubbing direction is aligned with the transmission axis of the polarizing plate. With this, the stereoscopic display device 2 suppresses the lens effect of the liquid crystal layer 23, and further, flattens the luminance characteristics. Besides, the width Wsl of the slit, the width Wbr of the barrier, the width A of the opening, and the barrier switching pitch Pe satisfy the formulae (1) and (2). This prevents luminance variation from occurring, even in a case where there are differences in the response speed of the liquid crystal layer 23.

As the present embodiment, an exemplary case where electrodes of 12 types are formed on the first substrate 61 is described. This configuration is merely an example, and the number of electrodes formed on the first substrate 61 is arbitrary.

### Configuration Example

The following description describes a more specific configuration example of a stereoscopic display device according to the present invention. This configuration example is not intended to limit the present invention.

With the rubbing direction of the alignment film of the switch liquid crystal panel being varied, a plurality of stereoscopic display devices were produced. These were produced in accordance with the configuration of the stereoscopic display device 1 except for the rubbing direction of the alignment film of the switch liquid crystal panel.

As the display panel 10, a 3.5-inch diagonal liquid crystal display panel with a resolution WVGA (800×480) was used. The pixel pitch PP of this liquid crystal display panel in the horizontal direction was 96 μm, and the width A of the opening of the pixel 110 in the horizontal direction was 62 μm. Regarding the switch liquid crystal panel 20, the following were set: the electrode pitch BP was approximately 32 μm; the electrode width W was 28 μm; the clearance S between the electrodes was 4 μm; and the barrier switching pitch Pe was approximately 16 μm.

With regard to each stereoscopic display device, the crosstalk and the lens effect were evaluated. The evaluation of the crosstalk was as follows: the barrier position was fixed, and angle characteristics of luminance were acquired; then, if the crosstalk value minimized at each position was 1.0% or less, the crosstalk was evaluated as “low”, and if the same was greater than 1.0%, the crosstalk was evaluated as “high”. The evaluation of the lens effect was similarly as follows. The barrier position was fixed, and angle characteristics of luminance were acquired. Then, if the minimum transmittance÷the maximum transmittance was 0.85 or less, the lens effect was evaluated as “great”; if the minimum transmittance÷the maximum transmittance was more than 0.85 and less than 0.90, the lens effect was evaluated as “small”; and if the minimum transmittance÷the maximum transmittance was 0.90 or more, the lens effect was evaluated as “minute”. It should be noted that the ratio of the luminance during 3D display (the barrier is ON) with respect to the luminance during 2D display (the barrier is OFF) is given as transmittance.

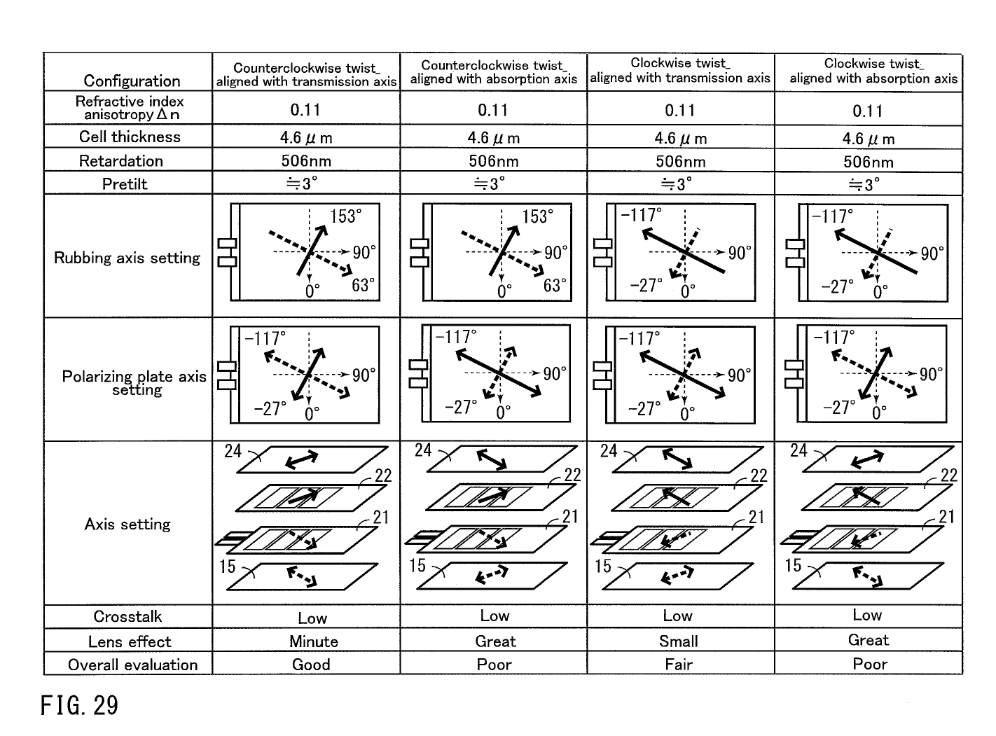

FIG. 29 is a table illustrating configurations of the produced stereoscopic display devices, and evaluation results of the crosstalk and evaluation results of the lens effect of the stereoscopic display devices.

As illustrated in FIG. 29, in each of the produced stereoscopic display devices, liquid crystal with refractive index anisotropy Δn of 0.11 was used as liquid crystal of the liquid crystal layer 23 of the switch liquid crystal panel 20, the thickness of the liquid crystal layer 23 (cell thickness) was set to 4.6 μm, and the retardation of the liquid crystal layer 23 was set to 506 nm. In each of the stereoscopic display devices, the alignment film was rubbed so that the pretilt angle of the liquid crystal molecules of the liquid crystal layer 23 was about 3°. In a case where the twist direction of the liquid crystal molecules is a counterclockwise twist direction, a chiral material for counterclockwise twist was added to the liquid crystal layer 23, and in a case where the twist direction of the liquid crystal molecules is a clockwise twist direction, a chiral material for clockwise twist was added to the liquid crystal layer 23.

Hereinafter, regarding the direction (angle), explanation is made with use of the same coordinate system as that in FIG. 9. In other words, the direction of 6 o'clock seen from the light emission side (the viewer side) is assumed to be 0°, and the counterclockwise direction is assumed to be a plus direction.

In the row of the “Rubbing axis setting”, the respective rubbing directions of the alignment films of the switch liquid crystal panels of the stereoscopic display device are schematically illustrated. In this row, the arrow of the broken line indicates the rubbing direction of the alignment film on the first substrate 21 (the substrate closer to the light source), and the arrow of the solid line indicates the rubbing direction of the alignment film on the second substrate 22 (the substrate farther from the light source).

In the row of the “Polarizing plate axis setting”, the respective directions of the transmission axes of the polarizing plates of the stereoscopic display devices are schematically indicated. In this row, the arrow of the broken line indicates the direction parallel to the transmission axis of the polarizing plate 15 (the polarizing plate closer to the light source), and the arrow of the solid line indicates the direction parallel to the transmission axis of the polarizing plate 24 (the polarizing plate farther from the light source).

In the row of the “Axis setting”, the relationship between the rubbing direction of the switch liquid crystal panel 20 and the directions parallel to the transmission axes of the polarizing plates 15 and 24 is schematically indicated.

The stereoscopic display device of the “Counterclockwise twist_aligned with transmission axis” had such a configuration that the twist direction of the liquid crystal in the switch liquid crystal panel 20 is set to the counterclockwise twist direction and the rubbing direction is aligned with the transmission axis of the polarizing plate. More specifically, the rubbing direction of the alignment film of the first substrate 21 was set to the direction at 63°, the rubbing direction of the alignment film of the second substrate 22 was set to the direction at 153°. The transmission axis of the polarizing plate 15 was set to be parallel to the direction at −117°, the transmission axis of the polarizing plate 24 was set to be parallel to the direction at −27°.

The stereoscopic display device of the “Counterclockwise twist_aligned with absorption axis” had such a configuration that the twist direction of the liquid crystal in the switch liquid crystal panel 20 was set to the counterclockwise twist direction and the rubbing direction was aligned with the absorption axis of the polarizing plate. More specifically, the rubbing direction of the alignment film of the first substrate 21 was set to the direction at 63°, and the rubbing direction of the alignment film of the second substrate 22 was set to the direction at 153°. The transmission axis of the polarizing plate 15 was set to be parallel to the direction at −27°, and the transmission axis of the polarizing plate 24 was set to be parallel to the direction at −117°.

The stereoscopic display device of the “Clockwise twist_aligned with transmission axis” had such a configuration that the twist direction of the liquid crystal in the switch liquid crystal panel 20 was set to the clockwise twist direction and the rubbing direction was aligned with the transmission axis of the polarizing plate. More specifically, the rubbing direction of the alignment film of the first substrate 21 was set to be the direction at −27°, and the rubbing direction of the alignment film of the second substrate 22 was set to be the direction at −117°. The transmission axis of the polarizing plate 15 was set to be parallel to the direction at −27°, and the transmission axis of the polarizing plate 24 was set to be parallel to the direction at −117°.

The stereoscopic display device of the “Clockwise twist_aligned with absorption axis” had such a configuration that the twist direction of the liquid crystal in the switch liquid crystal panel 20 was set to the clockwise twist direction, and the rubbing direction was aligned with the absorption axis of the polarizing plate. More specifically, the rubbing direction of the alignment film of the first substrate 21 was set to the direction at −27°, and the rubbing direction of the alignment film of the second substrate 22 was set to the direction at −117°. The transmission axis of the polarizing plate 15 was set to be parallel to the direction at −117°, the transmission axis of the polarizing plate 15 was set to be parallel to the direction at −27°.

Each of the stereoscopic display devices was capable of suppressing crosstalk by arranging the switch liquid crystal panel 20 on the viewer side with respect to the stereoscopic display device 10.

The stereoscopic display devices of the “Counterclockwise twist_aligned with absorption axis” and the “Clockwise twist_aligned with absorption axis” had a great lens effect. The stereoscopic display device of the “Clockwise twist_aligned with transmission axis” had a small lens effect. The stereoscopic display device of the “Counterclockwise twist_aligned with transmission axis” had the smallest lens effect.

From these results, regarding the relationship between the rubbing direction and the transmission axis of the polarizing plate, it was proved that being aligned with the transmission axis is preferable. Further, regarding the twist direction of the liquid crystal molecules, it was proved that the counterclockwise twist is preferred to the clockwise twist.

### OTHER EMBODIMENTS

The foregoing description describes embodiments of the present invention, but the present invention is not limited to the embodiments described above, and may be varied in many ways within the scope of the invention. Further, the embodiments can be carried out in combination appropriately.

In the embodiments mentioned above, examples are described in which a liquid crystal display panel is used as the display panel 10. However, an organic EL (electroluminescence) panel, a MEMS (micro electric mechanical system) panel, or a plasma display panel may be used in the place of the liquid crystal display panel.

### INDUSTRIAL APPLICABILITY

The present invention is industrially applicable as a stereoscopic display device.

1. A stereoscopic display device comprising:
a display panel for displaying an image with a plurality of pixels;
a switch liquid crystal panel that is arranged on a viewer side with respect to the display panel;
a first polarizing plate arranged between the display panel and the switch liquid crystal panel;
a second polarizing plate arranged on the viewer side with respect to the switch liquid crystal panel;
a position sensor for acquiring position information of a viewer; and
a control unit for moving a parallax barrier in which transmitting regions and non-transmitting regions are formed in periodic fashion in a predetermined alignment direction, in such a manner that the parallax barrier is moved in the predetermined alignment direction in accordance with the position information, and causing the switch liquid crystal panel to display the parallax barrier,
wherein the transmitting region has a width greater than a width in the alignment direction of an opening of each of the pixels,
the switch liquid crystal panel includes:
a first substrate arranged on a side of the display panel;
a first alignment film formed on the first substrate;
a second substrate arranged so as to be opposed to the first substrate;
a second alignment film formed on the second substrate; and
a liquid crystal layer arranged between the first substrate and the second substrate,
the rubbing direction of the first alignment film is parallel to the transmission axis of the first polarizing plate, and
the rubbing direction of the second alignment film is parallel to the transmission axis of the second polarizing plate.

2. The stereoscopic display device according to claim 1,
the rubbing direction of the second alignment film is a direction obtained by twisting the rubbing direction of the first alignment film counterclockwise as viewed from the viewer side.

3. The stereoscopic display device according to claim 1,
the control unit moves the parallax barrier with use of a predetermined barrier switching pitch as a minimum unit, and
the width in the alignment direction of the opening of each of the pixels, which is given as “A”, satisfies the following expressions:
A≦Wsl−2Pe, and
A≦Wbr−2Pe
where Wsl is a width of the transmitting region, Wbr is a width of the non-transmitting region, and Pe is the barrier switching pitch.

4. The stereoscopic display device according to claim 1,
wherein the control unit causes the parallax barrier to be displayed on the switch liquid crystal panel in such a manner that the width of the transmitting region and the width of the non-transmitting region are equal to each other.

5. The stereoscopic display device according to claim 1,
wherein the rubbing direction of the first alignment film and the rubbing direction of the second alignment film are different by 90° from each other.

6. The stereoscopic display device according to claim 1,
wherein the switch liquid crystal panel further includes:
a first electrode group that includes a plurality of electrodes that are formed on the first substrate and are arranged in the alignment direction at predetermined intervals; and
a second electrode group that includes a plurality of electrodes that are formed on the second substrate and are arranged in the alignment direction at the predetermined intervals, and
the first electrode group and the second electrode group are arranged so as to be deviated with respect to each other by half of the predetermined interval in the alignment direction.

7. The stereoscopic display device according to claim 1,
wherein the display panel is a liquid crystal display panel.
